(19) United States
(12) Patent Application Publication
(10) Pub. No.: US 2023/0305155 A1
(43) Pub. Date: Sep. 28, 2023

(54) AUTONOMOUS-READY SYSTEMS FOR VEHICLES

(71) Applicant: Waev Inc., Anaheim, CA (US)

(72) Inventors: Jacob P. Horky, Shoreview, MN (US); Sai Ashish Kanna, Telangana (IN); Eric L. Ross, Howell, MI (US); Curtis Daryl John Johnson, Minneapolis, MN (US)

(73) Assignee: Waev Inc., Anaheim, CA (US)

(21) Appl. No.: 18/099,666

(22) Filed: Jan. 20, 2023

Related U.S. Application Data
(60) Provisional application No. 63/301,884, filed on Jan. 21, 2022.

(51) Int. Cl. G01S 17/86; G01S 17/931; G01S 13/931; B60W 60/00

(52) U.S. Cl. CPC G01S 17/86; G01S 17/931; G01S 13/931; B60W 60/001; B60W 60/005; B60W 2420/42; B60W 2420/52

(57) ABSTRACT

Embodiments of the present disclosure relate to autonomous and autonomous-ready vehicles. In an embodiment, a vehicle comprises a plurality of ground engaging members which support a frame. The frame of the vehicle supports a plurality of sensors which include a first set of sensors on a top of the frame, a second set of sensors at a front of the frame, a third set of sensors at a rear of the frame, and a fourth set of sensors at a side of the frame. The vehicle further comprises processing circuitry communicatively coupled to the plurality of sensors.

### FIELD

The present invention relates to the uses and control of autonomous-ready systems for vehicles.

### BACKGROUND

Autonomous vehicles may transport cargo and passengers between locations without an operator using various sensors and control strategies. Arrangements of sensors, electronics configurations, and controller strategies are created with safety and redundancy in mind to provide fail-safe operation and provide safe passage for passengers and cargo. It is with respect to these and other general considerations that embodiments have been described. Also, although specific problems have been discussed, it should be understood that the embodiments should not be limited to solving the specific problems identified in the background.

### SUMMARY

In an exemplary embodiment of the present disclosure a vehicle is provided. The vehicle comprising: a plurality of ground engaging members, a frame supported by the plurality of ground engaging members, and a plurality of sensors supported by the frame. The plurality of sensors include: a first set of sensors positioned on top of the frame, a second set of sensors positioned at a front of the frame, a third set of sensors positioned at a rear of the frame, and a fourth set of sensors positioned at a side of the frame. The vehicle also comprising processing circuitry communicatively coupled to the plurality of sensors.

In an example thereof, the plurality of sensors includes at least one of a radar sensor, an ultrasonic sensor, or a Light Detection and Ranging Sensor.

In another example thereof, the processing circuitry is configured to perform a set of operations, wherein the set of operations comprises at least one of: calibrating a sensor of the plurality of sensors based on a test piece identified in a path of the vehicle; and adapting a behavior of the vehicle based on sensor output of the plurality of sensors.

In yet another embodiment of the present disclosure, a vehicle is provided. The vehicle comprising: a plurality of ground engaging members, a frame supported by the plurality of ground engaging members, a set of sensors supported by the frame, and a processing circuitry supported by the frame. The processing circuitry communicatively coupled to the plurality of sensors, and configured to perform a set of operations, wherein the set of operations comprise: obtaining a planned route for the vehicle, determining a change to at least one of a lateral jerk limit or a longitudinal jerk limit based on one or more inputs, and in response to determining the change, adapting the planned route for the vehicle based on the change.

In an example thereof, the inputs include at least one of a sensor output of a door sensor of the vehicle, a passenger request, a vehicle weight, a weight distribution, a tread characteristic of a ground engaging member, a suspension type of the vehicle, a vehicle speed, a vehicle turning radius, a vehicle wheelbase length, tire pressure, tire deflection, tire size, a determined surface composition, a determined surface grade, a determined ground type (e.g., gravel, pavement), an error state of the vehicle, a battery charge, or a characteristic of the planned route.

In another example thereof, the determined change is a change to reduce at least one of the lateral jerk limit or the longitudinal jerk limit.

In another example thereof, obtaining the planned route for the vehicle comprises generating the planned route based upon at least one of a selected transit time, a selected vehicle speed, or a selected route for the vehicle. In yet another example thereof, the planned route is generated based on at least one of a load condition of the vehicle, a determined surface grade, a longitudinal control constraint, or a lateral control constraint.

In yet another example of the present disclosure, a vehicle is provided. The vehicle comprising: a plurality of ground engaging members, a frame supported by the plurality of ground engaging members, and a set of sensors supported by the frame. The vehicle also comprising a processing circuitry supported by the frame and communicatively coupled to the plurality of sensors, the processing circuitry configured to perform a set of operations. The set of operations comprises identifying a condition associated with at least one of a surface grade of terrain of the vehicle, a roll back of the vehicle or a roll forward of the vehicle. The set of operations further comprising determining a vehicle operation adjustment based on the identified condition.

In another example thereof, the vehicle includes a powertrain, and the set of operations further comprises providing an instruction to the powertrain to provide additional propulsion torque to maintain a selected speed or to avoid roll-back in a stop-and-go operation on an incline of the terrain. In yet another example thereof, the set of operations further comprises providing a negative torque indication to an electric motor of the vehicle to maintain a selected speed or to avoid possible roll-forward in the stop-and-go operation.

In another example thereof, determining the vehicle operation comprises determining a brake force to maintain a selected speed or to avoid roll-forward in a stop-and-go operation on a decline of the terrain. Further, the determined vehicle operation is determined based on a set of predetermined vehicle operations associated with a load capacity of the vehicle or the surface grade of the terrain.

In another example thereof, wherein the processing circuitry includes a closed loop feedback circuit.

In yet another embodiment of the present disclosure, a method of detecting an object in an environment around a vehicle is provided. The method comprising: identifying an object in a field of view of at least one sensor of the vehicle, and determining whether the identified object intersect with a planned trajectory of the vehicle. When it is determined that the identified object intersects with the planned trajectory, determining an action for the vehicle to avoid the identified object, and controlling a subsystem of the vehicle to perform the determined action.

In another example thereof, the at least one sensor is a plurality of sensors to provide a surrounding view of the vehicle and the identified object is a dynamic object moving within a field of view of the plurality of sensors.

In another example thereof, determining whether the identified object intersects with the planned trajectory comprises generating an anticipated path of the dynamic object and determining the anticipated path intersects with the planned trajectory of the vehicle.

In another example thereof, the determined action includes at least one of actuating a brake of the vehicle, reducing a throttle of the vehicle, increasing the throttle, changing a steering angle, creating a noise, or creating a visual display.

In another example thereof, the sampling rate of the at least one sensor is increased in response to identifying the object.

In another example thereof, providing an indication associated with the determined action to a computing device of a user associated with the vehicle.

In yet another embodiment of the present disclosure, providing a vehicle. The vehicle comprising: a plurality of ground engaging members, a frame supported by the plurality of ground engaging members, the frame including an operator area. A processing circuitry configured to perform a set of operations comprising determining whether the operator area is configured for manual operation, and when it is determined that the operator area is configured for manual operation, configuring the vehicle to operate in a manual mode. When it is determined that the operator area is not configured for manual operation, configuring the vehicle to operate in an automatic mode.

In another example thereof, further comprising a manual control removably coupled to the operator area, and it is determined that the operator area is configured for manual operation when the manual control is removably coupled to the operator area. The manual control comprises at least one of a treadle pedal, a throttle pedal, a brake pedal, or a steering input.

In another example thereof, it is determined that the operator area is not configured for manual operation when a removable panel is installed in the operator area, wherein the removable panel obstructs access to a manual control of the operator area. Still further, the processing circuitry is configured to provide an indication when it is determined that the removable panel is not installed correctly.

In another example thereof, wherein an electrical input received from the manual control is used by the processing circuitry to control the vehicle in the manual mode. The vehicle comprises a key switch having a first position associated with the manual mode and a second position associated with the automatic mode, and determining whether the operator area is configured for manual operation further comprises determining whether the key switch is in the first position associated with the manual mode.

In yet another embodiment of the present disclosure, a vehicle is provided. The vehicle comprising: a plurality of ground engaging members, a frame supported by the plurality of ground engaging members, and a first supervisory gateway and a second supervisory gateway each supported by the frame. The vehicle further comprising a processing circuitry communicatively coupled to the first supervisory gateway and the second supervisory gateway, and the processing circuitry configured to perform a set of operations. The set of operations including controlling a vehicle subsystem using the first supervisory gateway, identifying a fault of the first supervisory gateway, and in response to identifying the fault of the supervisory gateway, using the second supervisory gateway to control operation of the vehicle.

In another example thereof, the first supervisory gateway is communicatively coupled to a first brake controller, a motor control unit and an electronic power steering system, and the second supervisory gateway is communicatively coupled to a second brake controller, the motor control unit and the electronic power steering.

In another example thereof, the processing circuitry uses the second supervisory gateway to bring the vehicle to a stop in response to determining the fault is associated with a first threshold. In another example thereof, the processing circuitry uses the second supervisory gateway to operate the vehicle at reduced functionality in response to determining the fault is associated with a second threshold, and generating an indication associated with the identified fault in response to determining the fault is associated with a third threshold.

In yet another embodiment of the present disclosure, a vehicle is provided. The vehicle comprising a plurality of ground engaging members, a frame supported by the plurality of ground engaging members, a steering rack coupled to at least one of the plurality of ground engaging members, and an electronic power system operably coupled to the steering rack. The electronic power system includes a first winding and a second winding, and a first controller is communicatively coupled to the first winding of the electronic power system and a second controller is communicatively coupled to the second winding of the electronic power system.

In another example thereof, the vehicle comprises a first steering angle sensor associated with the first controller and a second steering angle sensor associated with the second controller. The first controller of the vehicle is configured to control the first winding of the electronic power system based on the first steering angle sensor and the second controller is configured to control the second winding of the electronic power system based on the second steering angle sensor. Further, the first controller is communicatively coupled to the second controller, and the first controller is configured to generate a first adjusted steering angle based on a steering angle obtained from the second controller and control the first winding of the electronic power system based on the first adjusted steering angle. The second controller is configured to generate a second adjusted steering angle based on a steering angle obtained from the first controller and control the second winding of the electronic power system based on the second adjusted steering angle. The vehicle further using the second winding and the second controller to operate at a reduced functionality as a result of a failure of at least one of the first controller or the first winding, and the first winding and second winding form an electronic power steering motor of the electronic power steering system.

In yet another embodiment of the present disclosure, a vehicle is provided. The vehicle comprising: a plurality of ground engaging members and a frame supported by the plurality of ground engaging members. The frame supporting a first power source comprising a first battery and a first battery management system. The frame supporting a second power source comprising a second battery and a second battery management system. The vehicle also comprising a motor control unit electrically coupled to both the first power source and the second power source. The vehicle further comprising a first DC/DC converter configured to supply power to the motor control unit from the first power source and a second DC/DC converter configure to supply power to the motor control unit from the second power source.

In another example thereof a first low voltage battery is associated with the first power source and a second low voltage battery is associated with the second power source, and a first battery heater is associated with the first power source and a second battery heater is associated with the second power source.

In another example thereof the processing circuitry of the vehicle is configured to limit depletion of the first power source to a predetermined threshold, thereby retaining a power level of the first power source in the event of the second power source, and the predetermined threshold is user-configurable.

In yet another embodiment of the present disclosure, a vehicle is provided. The vehicle comprising a plurality of ground engaging members, a frame supported by the plurality of ground engaging members, a first low voltage battery and a second low voltage battery supported by the frame, and a DC/DC converter electrically coupled to the first low voltage battery and the second low voltage battery. The vehicle further comprising a vehicle subsystem electrically coupled to the first low voltage battery, the second low voltage battery and the DC/DC converter, and in the event the DC/DC converter fails, at least one of the first low voltage battery and the second low voltage battery provides power to the vehicle subsystem.

In another example thereof, the DC/DC converter provides power to the first low voltage battery and the second low voltage battery from a power source having a comparatively higher voltage than the first low voltage battery and the second low voltage battery.

In another example thereof, the vehicle subsystem is one of a set of critical subsystems including at least one of a braking system, an electronic power steering system, an autonomous driving system, a set of sensors, vehicle lighting, a communication system, a door of the vehicle, or a lock of the vehicle. Further, the first low voltage battery and the second low voltage battery are configured to prioritize the set of critical subsystems over other vehicle subsystems.

In yet another embodiment of the present disclosure, a method for controlling a battery system of a vehicle is provided. The method comprising: determining an ambient temperature, comparing the ambient temperature to a temperature threshold, and when it is determined that the vehicle is charging and the ambient temperature is below the temperature threshold, turning on a battery heater of the battery system to provide thermal energy to the battery. Further, in response to identifying a start of a route, turning off the battery heater.

In another example thereof, the method determines that the vehicle is done with the route before turning on the battery heater. The method further determines that the vehicle is parked at a home station before turning on the battery heater. The method further comprises a temperature threshold to be selected by one of an operator or a fleet manager.

In yet another embodiment of the present disclosure, a method for controlling a battery system of a vehicle is provided. The method comprising: determining a position of the vehicle, determining an ambient temperature, and determining a charge status of the battery. When the vehicle receives a start sequence, the battery heaters are turned on based upon at least one of the position of the vehicle, the ambient temperature, and the charge status of the vehicle. The battery heaters are turned on when ambient temperature threshold and the vehicle is positioned at a home station, and the battery heaters are also turned on when an ambient temperature is equal to or above a temperature threshold and the battery is fully charged.

In yet another embodiment of the present disclosure, a method of braking a vehicle with an electric motor is provided. The method comprising: receiving a brake request input that indicates a requested braking force, determining an ambient temperature of the vehicle. When the ambient temperature is below a predetermined threshold, engaging a mechanical brake of the vehicle to provide a first portion of the braking force and configuring the electronic motor to perform regenerative braking to provide a second portion of the braking force.

In another example thereof, the combination of the first portion of the braking force from the mechanical brake and the second portion of the braking force from regenerative braking provide the requested braking force. Further, configuring the electric motor to perform regenerative braking comprises providing a sequence of interrupted negative torque signals.

In yet another embodiment of the present disclosure, a method of providing anti-lock braking for a vehicle with an electric motor is provided. The method comprising detecting a slip of at least one of a plurality of ground engaging members of the vehicle and in response to detecting the slip. The method further comprising determining a first braking force associate with a brake of the vehicle, determining a second braking force associated with the electric motor, and configuring the vehicle according to the determined first braking force and the determined second braking force. Configuring the vehicle further includes providing an alternating signal to the electric motor associated with the determined second braking force, the alternating signal comprising a first torque request and a second torque request. The first torque request is a negative torque and the second request is for no torque.

In another example thereof, the second braking force is greater than the first braking force when it is determined that an ambient temperature associated with the vehicle is above a predetermined threshold.

In another example thereof, the first braking force is greater than the second braking force when it is determined that an ambient temperature associated with the vehicle is below a predetermined threshold.

In yet another embodiment of the present disclosure, a vehicle is provided. The vehicle comprising a plurality of ground engaging members, a frame supported by the plurality of ground engaging members, a first passenger section of the frame comprising a first seat. The vehicle further comprising an imaging sensor supported by the frame and positioned to observe the first passenger section, the imaging sensor configured to observe a first passenger within the first seat.

In another example thereof, the sensor is positioned longitudinally forward of the first seat. The first passenger section comprises a second seat, and the imaging sensor is further configured to observe a second passenger within the second seat. The vehicle further comprising a controller configured to detect if the first passenger is wearing a seat belt, and the controller is further configured to reduce performance of the vehicle when it is determined that the passenger is not wearing the seat belt. The imaging sensor is one of a RADAR sensor, a LiDAR sensor, or an optical sensor.

In yet another embodiment of the present disclosure, a vehicle is provided. The vehicle comprising a plurality of ground engaging members, a frame supported by the ground engaging members, a door supported by the frame, a latching mechanism coupled between the door and the frame adjacent to a door hinge of the door. The vehicle further comprising a controller supported by the frame, the controller communicatively coupled to the latching mechanism to control a position of the door, and the latching mechanism is configured to move the door between a first position and a second position. The vehicle further comprising a sensor supported by the frame, the sensor configured to observe a passenger within the vehicle.

In another example thereof, the controller is configured to cause the latching mechanism to move the door between the first position and the second position when the vehicle is at vehicle stop of a route of the vehicle. The locking mechanism is configured to lock and unlock the door to the frame, and the locking mechanism locking the door to the frame when the door is in the first position.

In yet another embodiment of the present disclosure, a method of controlling the operation of a vehicle is provided. The method comprising identifying a vehicle power-on sequence, and in response to the identification of the vehicle power-on sequence, determining an air pressure of a wheel of the vehicle, and in response to determining the air pressure of the wheel is below an air pressure threshold, preventing operation of the vehicle. The method further comprising providing a notification to a user device that the air pressure of the wheel is below the air pressure threshold. The method further comprising permitting normal operation of the vehicle in response to determining the air pressure of the wheel is above the air pressure threshold.

In yet another embodiment of the present disclosure, a method of controlling the operation of a vehicle is provided. The method comprising identifying a vehicle power-on sequence, and in response to the identification of the vehicle power-on sequence, determining an air pressure of a wheel of the vehicle, and in response to determining the air pressure of the wheel is below an air pressure threshold, altering a vehicle characteristic, wherein the vehicle characteristic is a maximum vehicle speed.

### BRIEF DESCRIPTION OF THE DRAWINGS

FIG. 1 is a top view of a conceptual autonomous-ready vehicle, in accordance with certain embodiments of the present disclosure;

FIG. 2 is a block diagram of a system for controlling a conceptual autonomous-ready vehicle, in accordance with embodiments of the present disclosure;

FIG. 3A is an exemplary pedal input for a conceptual autonomous-ready vehicle, in accordance with embodiments of the present disclosure;

FIG. 3B is an exemplary switch for a conceptual autonomous-ready vehicle, in accordance with embodiments of the present disclosure;

FIG. 4 is a flow diagram of a mode switching feature for a conceptual autonomous-ready vehicle, in accordance with embodiments of the present disclosure;

FIG. 5A is a flow diagram of a mode switching feature for a conceptual autonomous-ready vehicle, in accordance with embodiments of the present disclosure;

FIG. 5B is a flow diagram of a subprocess of the flow diagram of FIG. 5 for a conceptual autonomous-ready vehicle, in accordance with embodiments of the present disclosure;

FIG. 6 is a block diagram of an autonomous system for a conceptual autonomous-ready vehicle, in accordance with embodiments of the present disclosure;

FIG. 7 is a flow diagram of a fault-related notification system for a conceptual autonomous-ready vehicle, in accordance with embodiments of the present disclosure;

FIG. 8 is a flow diagram of a fault-related notification system for a conceptual autonomous-ready vehicle, in accordance with embodiments of the present disclosure;

FIG. 9A is an embodiment of an electronic power steering system for a conceptual autonomous-ready vehicle, in accordance with embodiments of the present disclosure;

FIG. 9B is an embodiment of an electronic power steering system for a conceptual autonomous-ready vehicle, in accordance with embodiments of the present disclosure;

FIG. 9C is an embodiment of an electronic power steering system for a conceptual autonomous-ready vehicle, in accordance with embodiments of the present disclosure;

FIG. 10 is a block diagram of an electronic power steering system for a conceptual autonomous-ready vehicle, in accordance with embodiments of the present disclosure;

FIG. 11 is a block diagram of a battery architecture for a conceptual autonomous-ready vehicle, in accordance with embodiments of the present disclosure;

FIG. 12 is a block diagram of a low-voltage battery architecture for a conceptual autonomous-ready vehicle, in accordance with embodiments of the present disclosure;

FIG. 13 is a flow diagram of a battery heater control strategy for a conceptual autonomous-ready vehicle, in accordance with embodiments of the present disclosure;

FIG. 14 is a block diagram of a brake system for a conceptual autonomous-ready vehicle, in accordance with embodiments of the present disclosure;

FIG. 15 is a chart associated with a brake system for a conceptual autonomous-ready vehicle, in accordance with embodiments of the present disclosure;

FIG. 16 is a top view of a conceptual autonomous-ready vehicle, in accordance with certain embodiments of the present disclosure;

FIG. 17 is a perspective view of a door actuating system for a conceptual autonomous-ready vehicle, in accordance with certain embodiments of the present disclosure;

FIG. 18 is a perspective view of a door locking system for a conceptual autonomous-ready vehicle, in accordance with certain embodiments of the present disclosure;

FIG. 19 is a flow diagram of a tire pressure monitoring system for a conceptual autonomous-ready vehicle, in accordance with certain embodiments of the present disclosure; and

FIG. 20 is a block diagram of a computing system for implementing aspects of the present disclosure.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances, throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

As discussed herein, a vehicle 2 may include a manually operated vehicle, a semi-autonomous vehicle, or an autonomous vehicle. In some examples, the vehicle 2 may include any manual, semi-autonomous, or autonomous vehicle designed to move cargo, people, or both.

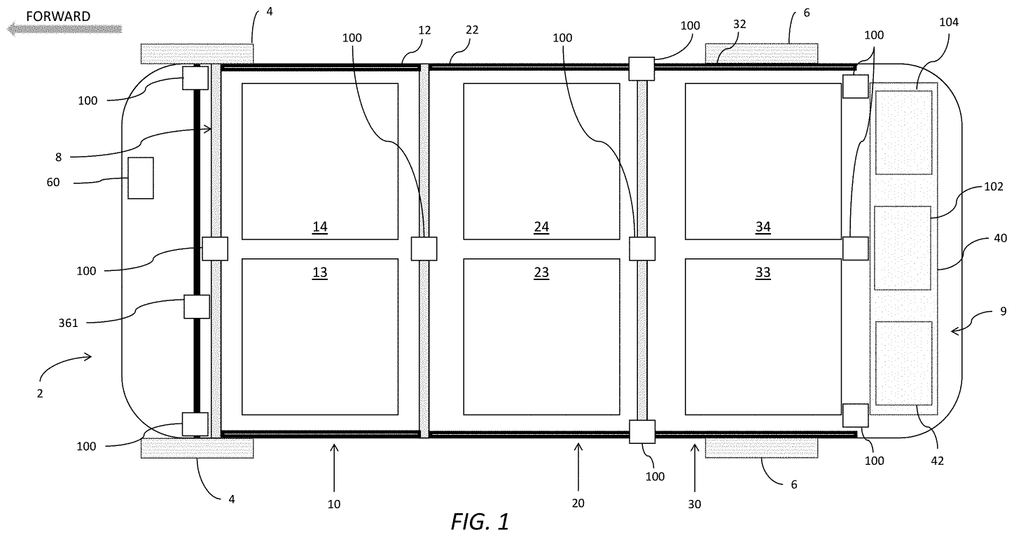

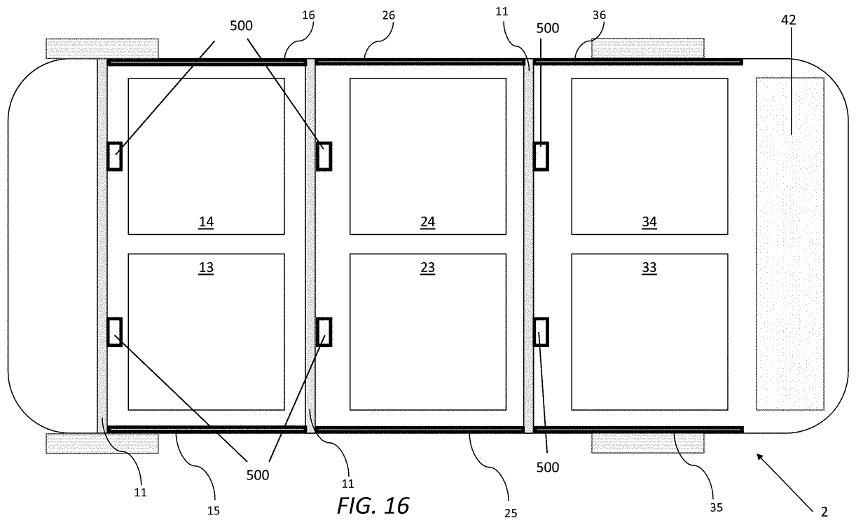

Referring to FIG. 1, an embodiment of vehicle 2 is shown with a plurality of front ground engaging members 4 and a plurality of rear ground engaging members 6 supporting a frame assembly 8. Ground engaging members may be wheels, tracks, skis, or other suitable members. Vehicle 2 further includes a body assembly 9 supported by frame assembly 8. In the present embodiment, vehicle 2 includes a first passenger section 10, a second passenger section 20, and a third passenger section 30. Illustratively, first passenger section 10 includes a first passenger entrance 12, second passenger section 20 includes a second passenger entrance 22, and third passenger section 30 includes a third passenger entrance 32. Each of first passenger entrance 12, second passenger entrance 22, and third passenger entrance 32 further include a pair of doors 15, 16, 25, 26, 35, 36 (FIG. 16) configured to open and close to allow passengers to enter and exit vehicle 2. In the present embodiment, each of first passenger section 10, second passenger section 20, and third passenger section 30 include a seating area (not shown) configured to hold two passengers. In various embodiments, the seating area may hold more or less than two passengers. In various embodiments, vehicle 2 includes only first passenger section 10. In various embodiments, vehicle 2 includes first passenger section 10 and second passenger section 20. In various embodiments, vehicle 2 includes a fourth passenger section, or more.

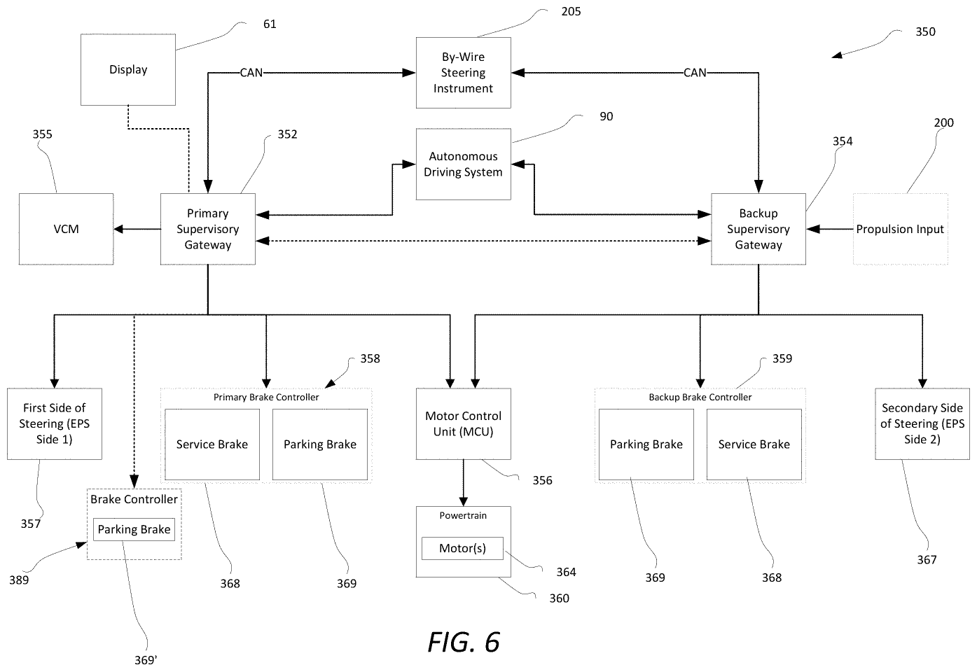

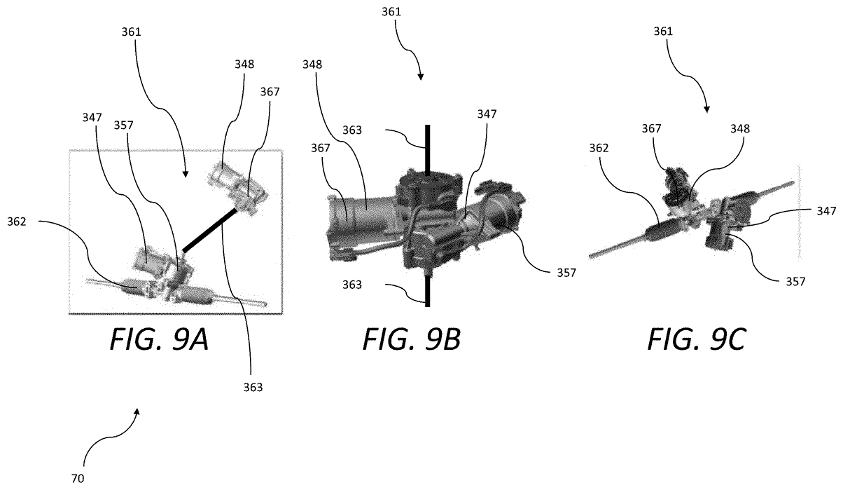

In the present embodiment, vehicle 2 further includes a steering system 70 (FIG. 9A-9C) configured with an electronic power steering system 361, comprising a first winding 357 and a second winding 367. In the present embodiment, electronic power steering system 361 is operably coupled to front ground engaging members 4 through steering system 70, which may include a steering rack 362, and a steering shaft 363 configured to couple with front ground engaging members 4. Vehicle 2 further includes a braking system including at least one brake controller 358 (FIG. 6) controlling the operation of a plurality of brakes, such as, for example, a service brake 368 and a parking brake 369. In various embodiments, vehicle 2 includes a backup brake controller 359, an auxiliary brake controller 389, and a backup parking brake 369′. Vehicle 2 further includes a charger 60. In the present embodiment, charger 60 is positioned at a front of vehicle 2. In various embodiments, charger 60 may be placed in the rear of the vehicle 2, on a side of vehicle 2, on the bottom of vehicle 2, or on top of vehicle 2.

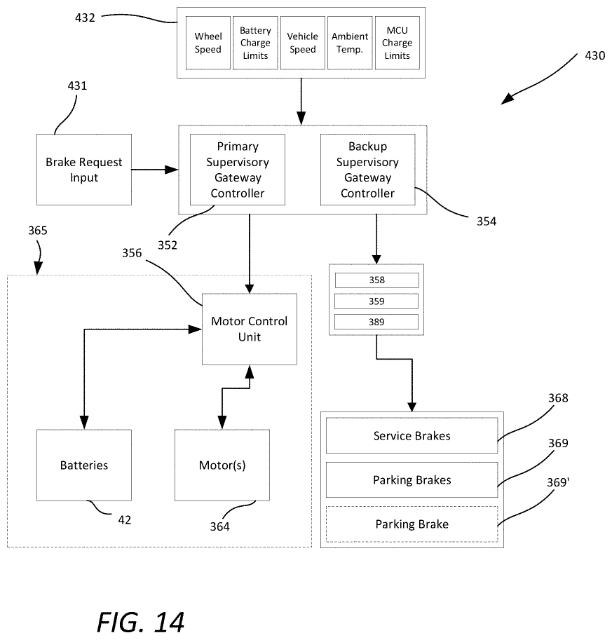

Still referring to FIG. 1, vehicle 2 further includes a plurality of sensors 100. In the present embodiment, sensors 100 are Light Detection and Ranging (LIDAR) sensors. In various embodiments, sensors 100 may be optical sensors, radar sensors, ultrasonic sensors, cameras, or the like. In various embodiments, a combination of sensors may be used. The vehicle 2 may include one or more sensors 100 and a memory 104 operatively coupled to a processing circuitry 102 configured to autonomously determine an operation of the vehicle 2 in the constrained environments using an Autonomous Driving System. In the present embodiment, processing circuitry 102 is primarily located above rear ground engaging members 6 in a trunk compartment 40. In various embodiments, processing circuitry 102 may be positioned anywhere on vehicle 2 to be supported by the frame assembly 8. In various embodiments, trunk compartment 40 may house at least one battery 42. In various embodiments, trunk compartment 40 may house a plurality of batteries 42. Vehicle 2 further includes a powertrain 360 (FIG. 6) configured to provide propulsion to at least one ground engaging member. In the present embodiment, powertrain 360 includes a plurality of motors 364 (FIG. 14) individually coupled to the ground engaging members 4, 6. In various embodiments, a single motor 364 may control all ground engaging members 4, 6. In various embodiments, a single motor 364 may be coupled to the front ground engaging members 4, and a single motor 364 may be coupled to the rear ground engaging members 6. In various embodiments, any combination of motors 364 may be coupled to any combination of ground engaging members 4, 6. In the present embodiment, powertrain 360 is an electric powertrain. In various embodiments, an internal combustion engine may be used, and still in further embodiments, powertrain 360 may be any propulsive unit configured to provide power to ground engaging members 4, 6.

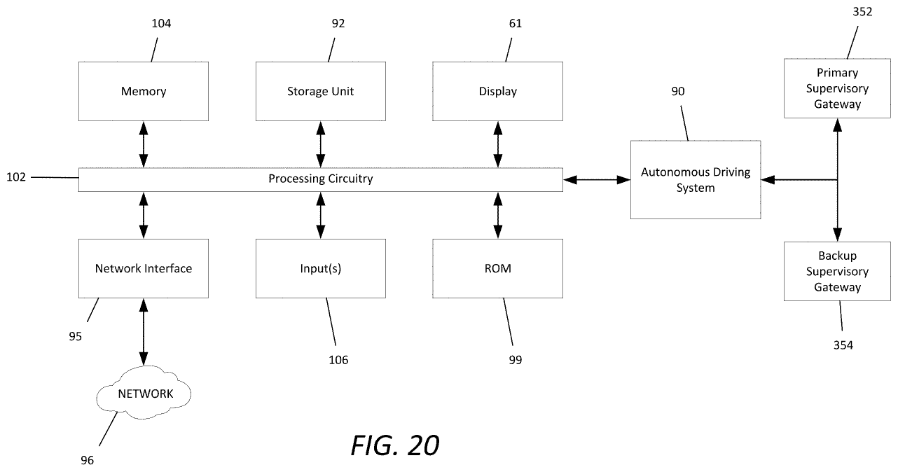

Turning to FIG. 20, vehicle 2 further includes an Autonomous Driving System (ADS) 90 operated by the processing circuitry 102. In the present embodiment, processing circuitry 102 is configured to receive instructions to execute the ADS 90 through a primary supervisory gateway 352 and a backup supervisory gateway 354 which will be described in greater detail below. Further, processing circuitry 102 includes a network interface 95 configured to connect processing circuitry to a network 96. Additionally, processing circuitry 102 is coupled to a storage unit 92 and a Read Only Memory (ROM) 99.

Positioning of Sensors

In the present embodiment, vehicle 2 includes a plurality of sensors 100 supported by frame 8 or body 9. Illustratively, sensors 100 are positioned on top of vehicle 2, on the front of vehicle 2, on the rear side of vehicle 2, and positioned to face the side of vehicle 2. In some examples, positioning of one or more sensors may be selected to provide a selected coverage area of vehicle 2. In some examples, the selected coverage of vehicle 2 may include the entirety of the surrounding area of vehicle 2, e.g., 360-degrees around vehicle 2. In various embodiments, the selected coverage of vehicle 2 may be less than an entirety of the surrounding area of vehicle 2.

In one example, the one or more sensors 100 may be calibrated using a test piece detection process. In one example, a plurality of test pieces may be placed in the path of vehicle 2 (including onboard payload, equipment, towed trailer and/or trailer payload) while vehicle 2 is traveling at a variety of speeds. In an embodiment, those speeds are 0%, 50%, and 100% of full vehicle speed. In the calibration process, a plurality of test pieces will be used for the sensors 100 to detect and calibrate to, and the test pieces may include a plurality of characteristics depending upon what type of sensors are being calibrated. In the case of an optical sensor being used as detection devices, the test pieces may be a cylindrical test piece or a flat test piece with a predetermined external surface reflectance and optical density. In an embodiment for testing optical sensors, the external surface reflectance of the cylindrical test piece is 6% or less and the optical density is 1.22 or less, and the flat test piece may have a highly reflective, polished metal surface of at least 88% reflectivity. In another embodiment for testing ultrasonic sensors, the flat test pieces may also have a highly reflective surface.

Still referring to the calibration of sensors 100, the following test pieces also apply: (a) a test piece with a diameter of 200 millimeter (mm) and a length of 600 mm lying on and at 0° and 45° to the path of the vehicle, at a range equivalent to the vehicle safe stopping distance and positioned at the left-most, right-most and center of the vehicle path, (b) a test piece with a diameter of 70 mm and a height of 400 mm set vertically at a range equivalent to the vehicle safe stopping distance and positioned at the left-most, right-most and center of the vehicle path, (c) a test piece with a flat surface measuring 500 mm square set vertically, and at test angles of 0° and 45° perpendicular to the path of vehicle 2, with closest point of the test piece at a range equivalent to the vehicle safe stopping distance and positioned at the left-most, right-most and center of the vehicle path.

In some examples, sensors 100 may be positioned on vehicle 2 or otherwise shrouded to protect sensors from impact with obstructions.

In the present embodiment, sensors 100 include a LiDAR sensor on the roof of vehicle 2, an exemplary sensor for the roof of vehicle 2 is the Pandar64 or the Pandar128 available from Hesai, Palo Alto, California. Further, vehicle 2 includes four LiDAR sensors, one mounted on each corner, and exemplary sensors for the corners of vehicle 2 are Hesai PandarQts LiDAR sensors. Additionally, roof mounted, and corner mounted LiDAR cleaning systems may be used to avoid obscuring LiDAR field of view.

Vehicle Stability

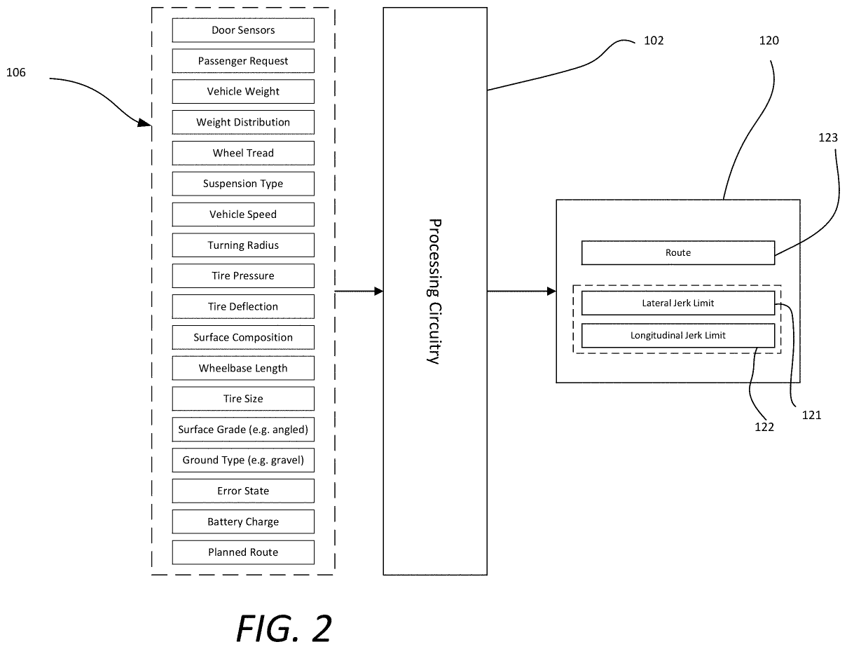

Turning to FIG. 2, the stability of vehicle 2 is maintained throughout a planned trip 120 to avoid the vehicle 2 overturning or losing control during acceleration, deceleration, or turning. In the present embodiment, planned trip 120 includes a route 123, a lateral jerk limit 121, and a longitudinal jerk limit 122. In the present embodiment, lateral jerk limit 121 and longitudinal jerk limit 122 are values that limit the rate of change of an acceleration of vehicle 2. Limiting high jerk values prevent loss of control of vehicle 2 during cornering events, acceleration events, and deceleration events. Lateral jerk limit 121 and longitudinal jerk limit 122 will be calculated based upon a variety of inputs 106 regarding the current state of vehicle 2. As seen in FIG. 2, inputs 106 include, but are not limited to, door sensors, passenger requests, vehicle weight, weight distribution, wheel tread characteristics, suspension type, vehicle speed, turning radius, tire pressure, tire deflection, surface composition, wheelbase length, tire size, surface grade (e.g., angled downward or upward), ground type (e.g., gravel, pavement), error state of the vehicle, battery charge, and planned route. Surface grades may include a slope (e.g., angle) of a surface and/or changes in a relative elevation of a surface (e.g., bumps). Surface composition may also be a factor (e.g., loose gravel, cement, dirt, acrylic flooring, etc.). Inputs 106 are processed within processing circuitry 102 and provide lateral jerk limit 121 and longitudinal jerk limit 122.

In the present embodiment, various inputs may result in a determination to reduce jerk limits 121, 122 from their default values if it is determined that the inputs are conducive to loss of control of vehicle 2 (e.g., if the ground is made of loose gravel, vehicle 2 may more easily lose control, and jerk values 121 or 122 may be limited below a default value). In various embodiments, the vehicle may be configured to determine a planned trajectory to satisfy a selected transit time, speed, or route for the vehicle. The planned trajectory may be constrained by one or more lateral acceleration limits to avoid unnecessary oversteering which may lead to instability of the vehicle. In some examples, the planned trajectory may be based on, at least in part, load conditions, surfaces grades, longitudinal control constraints, lateral control constraints, or other operations of the vehicle.

Ramps

Vehicle 2 may operate in a constrained environment consisting of ramps or other inclined surfaces. For example, the vehicle 2 may be configured to determine or detect a condition, such as one or more of a surface inclination, declination, or other surface grade, and/or a roll back or forward (e.g., due to gravity). Accordingly, the vehicle 2 may determine a speed adjustment to compensate for an incline, a stop-and-go or braking adjustment, or determine any of a variety of other adjustments to operation of the vehicle. In some examples, operations of the vehicle on inclines may be predetermined for any applicable load capacities over a selected range of grade surfaces.

For example, during an uphill climb, the vehicle 2 may be configured to determine and provide to powertrain 360 (FIG. 6) an additional propulsion torque to maintain a selected speed and/or to avoid roll-back in a stop-and-go operation on an incline. As another example, during a downhill descent, the vehicle may be configured to determine a brake force to maintain a selected speed and/or to avoid possible roll-forward in a stop-and-go operation on a decline. As another example, a negative torque may be applied to any or all of electric motors 364 of the vehicle 2 to maintain a selected speed and/or to avoid possible roll-forward in a stop-and-go operation on a decline.

In some examples, the above determinations may be based on, at least in part, one or more of a speed-based controller, aerodynamic forces, rolling resistance, gravity, or other factors affecting an operation of the vehicle 2. For example, a speed controller of the vehicle 2 may be configured to control an error between a selected commanded speed and a detected actual speed of the vehicle 2. In some examples, a gain scheduling of the speed controller may be based on field testing for selected surface grades. For example, on a surface grade that requires a higher power output to maintain a specific speed (e.g., gravel or uphill, etc.), a positive gain may be used by the speed controller to maintain a specific speed. In another example, on a surface grade that has a downhill profile, a negative gain may be used by the speed controller so that vehicle 2 does not go faster than the operator or fleet manager desires. As another example, the vehicle may be configured to compensate an acceleration command and/or a deceleration command based on, at least in part, rolling resistance of the vehicle 2, gravity, and/or aerodynamic forces acting on the vehicle 2.

In the present embodiment, vehicle 2 may implement a closed loop feedback circuit to maintain a desired speed on an inclined ramp or a declined ramp. The closed loop feedback circuit may measure the error between selected commanded speed and detected actual speed and adjust the output provided to the motor(s) 364 and/or the brake(s).

Detection of Moving Object and Stationary Object

In the present embodiment, vehicle 2 is configured to detect objects in the environment around vehicle 2. Sensors 100, as previously described, provide a full surrounding view of vehicle 2. Objects may be stationary objects or may also be dynamic objects moving within the field of view of sensors 100. In various embodiments, stationary objects or dynamic objects may be temporarily occluded by other stationary or dynamic objects. In the present embodiment, sensors 100 may view a stationary object or dynamic object while vehicle 2 is turned on and/or moving. If vehicle 2 detects a stationary object or a dynamic object, vehicle 2 may respond to avoid collision with the object. Examples of stationary objects may include, but are not limited to trees, fire hydrants, mailboxes, signs, curbs, buildings, stairs, parked vehicles, bridges, etc. Examples of dynamic objects may include, but are not limited to pedestrians, cyclists, moving vehicles, animals, autonomous vehicles, etc.

In the present embodiment, when vehicle 2 detects a dynamic object, vehicle 2 may use processing circuitry 102 to determine an anticipated path of the dynamic object, and to determine if the anticipated path of the dynamic object will intersect with the planned trajectory of vehicle 2. If the anticipated path of the dynamic object is determined to intersect with the planned trajectory of vehicle 2, processing circuitry 102 may determine an action (e.g., maneuver) of vehicle 2 to avoid the anticipated path of the dynamic object. This action may include changing a vehicle subsystem such as actuating brakes 368, 369, reducing throttle, increasing throttle, changing steering angle, and may also include creating a noise, creating a visual display, or other action to avoid collision with the object. In various embodiments, vehicle 2 will provide both a vehicle subsystem response as well as a noise and/or display in the event vehicle 2 determines it will intersect with the anticipated path of the dynamic object. In various embodiments, if vehicle 2 detects a dynamic object, processing circuitry 102 may increase the sampling rate of sensors 100 to increase the fidelity of sensors 100 during a potential collision scenario. The vehicle 2 may also be configured to alert a user or remote user of the unplanned or unpredicted movements through use of a wireless communication protocol.

Vehicle Architecture

In the present embodiment, vehicle 2 is configured to operate in a manual mode and an autonomous mode. In manual mode, vehicle 2 includes a throttle input 200, such as a pedal, and a steering input, such as a steering wheel. In various embodiments, throttle input and steering input may operate in a “by-wire” system, meaning that the throttle input and steering input each provide electrical signals as an output, which are received by processing circuitry 102 and the Autonomous Driving System (ADS) 90. In various embodiments, throttle input may operate with a cable, and a steering input may operate by a user providing torque to the steering assembly. In an autonomous mode, the throttle input and steering input may be removable or coverable so riders do not interfere with the operation of vehicle 2. In the present embodiment, as throttle input 200 is actuated, a signal is sent to the Autonomous Driving System 90 and requests a current to be provided to the powertrain 360 and motors 364 (FIG. 6).

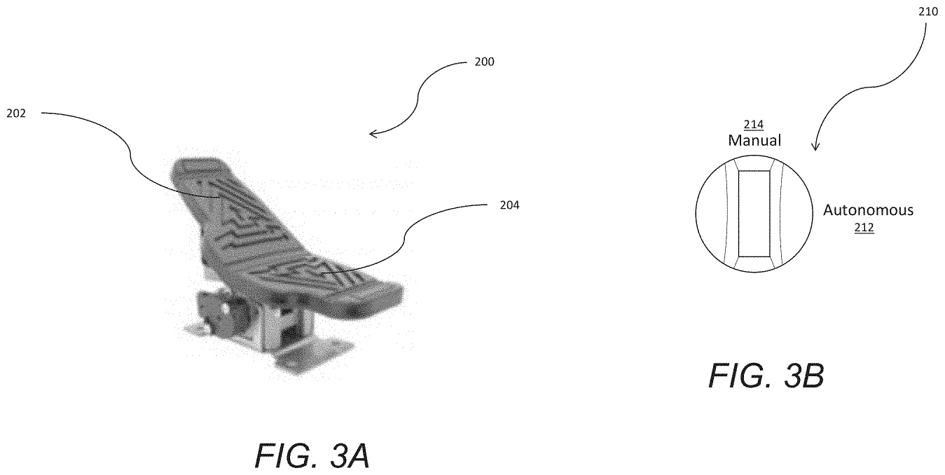

Referring to FIG. 3A, throttle input 200 may be a treadle pedal, which has a forward portion 202 and a rearward portion 204. A force placed on the forward portion 202 sends a signal to processing circuitry 102 to provide a forward propulsion to vehicle 2, and a force placed on the rearward portion 204 sends a signal to processing circuitry 102 to provide a braking force (e.g., hydraulic braking force) to vehicle 2. In various embodiments, throttle input is a normal throttle pedal and vehicle 2 further includes a brake pedal (not shown). In various embodiments, throttle input 200 may be coupled to vehicle 2 by removable fasteners or magnets (not shown) and an electrical connection (not shown) to vehicle 2. In various embodiments, steering input may be removable through the use of fasteners or magnets (not shown) and an electrical connection. In various embodiments, an electromagnetic connection may be used to transfer both power, electrical signals, and act as a connection point for operator controls to vehicle 2. In other examples, signals generated by throttle input 200 and/or the steering input may be wirelessly received by processing circuitry 102. Vehicle 2 may be transitioned between a manual mode and an autonomous mode by removing operator controls.

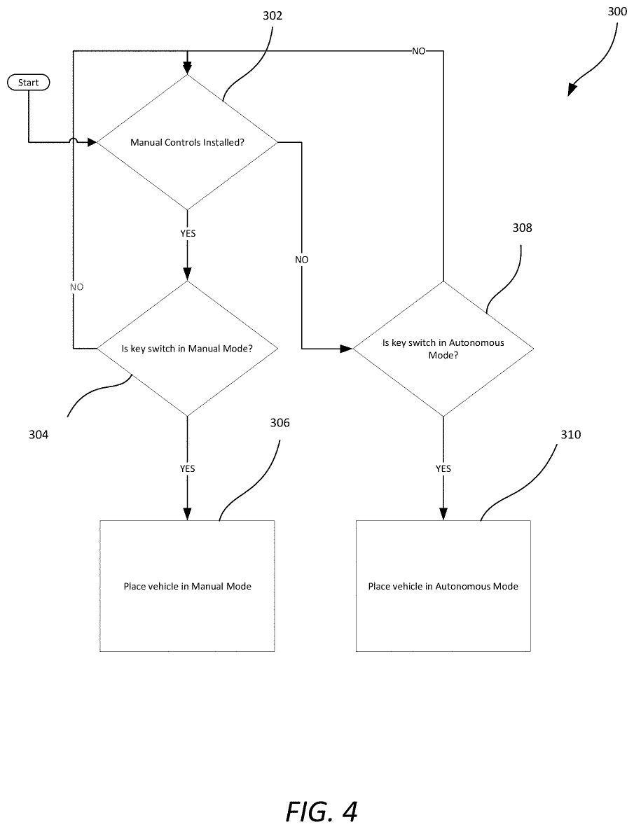

Referring now to FIG. 4, a process 300 may be used to transition vehicle 2 between a manual mode and an autonomous mode. Illustratively, block 302 makes an inquiry to determine if manual controls (e.g., throttle input and steering input) are installed on vehicle 2. If manual controls are installed, process 300 moves to block 304 to determine if a key switch 210 (FIG. 3B) is selecting a manual mode 214. In the present embodiment, key switch 210 is a rotary knob with discrete selections. In various embodiments, key switch 210 may also be a toggled switch, a slider, a touch screen, a lever, or other type of switch. Key switch 210 acts as a confirmation within process 300 that the user desires to switch between modes. Referring again to process 300, if key switch is determined to be placed in manual mode 214, vehicle 2 transitions into manual mode 214 at block 306. If key switch 210 is determined not to be in manual mode, process 300 goes back to block 302 to once again determine if manual controls are installed on vehicle. In some examples, an indication may be provided that a mismatch has been identified between the configuration of vehicle 2 (e.g., that the manual controls are installed) and key switch 210.

By contrast, if manual controls are not installed, block 302 will lead to block 308, which evaluates if key switch 210 indicates an autonomous mode 212. If it is determined that the key is in autonomous mode 212, and no manual controls are installed, block 308 leads to block 310 which transitions vehicle 2 into an autonomous mode. In the event key switch 210 is not in autonomous mode 212, block 308 leads process 300 back to block 302 to start process 300 over again. As noted above, a mismatch indication may be provided. In various embodiments, key switch 210 may further include a semi-autonomous mode (not shown) that may enable vehicle 2 with intermediate functionality between manual mode 214 and autonomous mode 212.

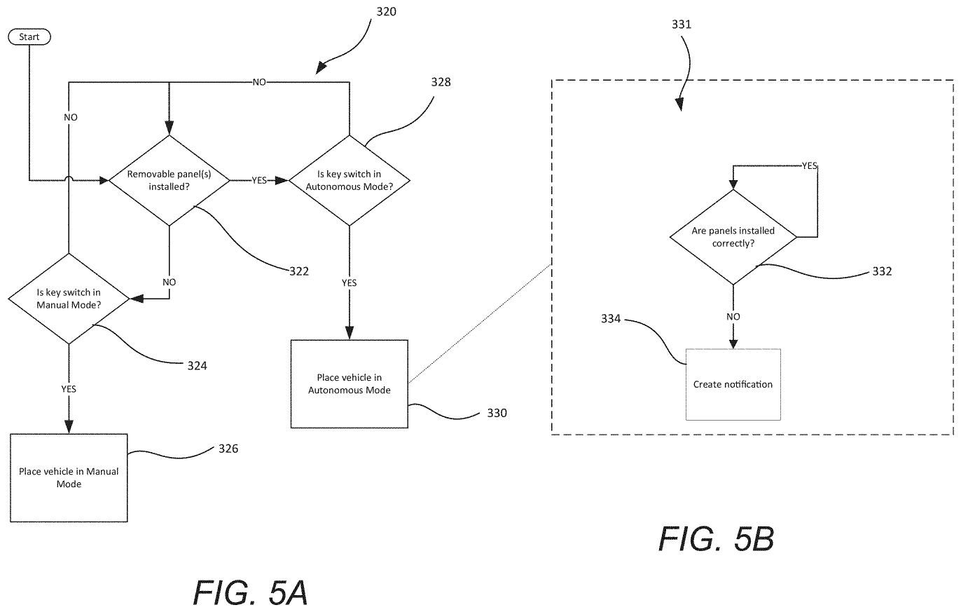

Referring now to FIGS. 5A and 5B, another method of transitioning vehicle 2 between an autonomous mode and a manual mode will be described. Illustratively, process 320 illustrates a method involving removable panels (not shown) which cover up operator inputs (e.g., throttle input, steering input, and brake input). Removable panels are intended to prohibit passengers within vehicle 2 from tampering with operator inputs or other controls. Illustratively, process 320 begins at block 322 where it is determined whether the removable panels are installed on vehicle 2. Removable panels may be determined to be installed using a variety of methods. For example, removable panels and/or vehicle 2 may include hall-effect sensors to determine if a removable panel is detected. Further, removable panels may utilize switches which may communicate an installation status to processing circuitry 102. If it is determined that removable panels are not installed on vehicle 2, process 320 assumes that vehicle 2 is intended to be used in a manual mode, because operator inputs are exposed to passengers of vehicle 2, and process 320 moves to block 324 to determine if key switch 210 is positioned in manual mode 214. If key switch 210 is in manual mode 214, process 320 moves to block 326 and confirms that vehicle 2 is supposed to be in manual mode, and transitions vehicle 2 into manual mode. If key switch 210 is determined to not be in manual mode in block 324, process 320 moves back to block 322 and starts over. If block 322 determines that removable panels are installed on vehicle 2, process 320 moves to block 328 and determines if key 210 is positioned in autonomous mode 212. If it is determined that key switch 210 is in autonomous mode 212, process 320 moves to block 330 and confirms that vehicle 2 is supposed to be in autonomous mode, and transitions vehicle 2 into autonomous mode 212.

Now referring to FIG. 5B, a subprocess 331 within block 330 will be described in greater detail. It is perceived that during movement of vehicle 2, it is desired that removable panels stay in an installed configuration. However, it is understood that components can become displaced, can break, or otherwise be dislodged from their intended installation location. Subprocess 331 is intended to determine whether removable panels are installed correctly on a continuous basis during the operation of vehicle 2. Illustratively, block 332 inquires as to whether the various removable panels are installed correctly. If it is determined that removable panels are not installed correctly, subprocess 331 moves to block 334 which creates a notification of the improperly installed removable panel. If block 332 determines that the removable panels are installed correctly, subprocess 331 loops back to block 332 to repeatedly inquire about the status of the removable panels. In embodiments, subprocess 331 operates continuously. In various embodiments, subprocess 331 operates on an intermittent basis. In various embodiments, subprocess 331 is triggered based upon an indication of a turn, a positive or negative acceleration, or based upon a jerk limit. A created notification in block 334 may include various types of notifications, including but not limited to an audible noise, a visual display, a message to a fleet administrator, a message to a network 96, or other type of notification. It will be appreciated that a variety of alternative or additional actions may be performed as a result of determining that the removable panels are not installed correctly. For example, operation of the vehicle may be suspended so as to enable a rider to address the identified issue, or the vehicle may continue to operate autonomously in the absence of user input to the operator controls.

Referring now to FIGS. 4-5B, in both processes 300 and 320, the transition process may also incorporate use of a parking brake 369 (FIG. 6). In the present embodiment, when process 300 moves between block 304 and block 306, as well as block 38 and 310, the parking brake 369 may be engaged to prohibit vehicle 2 from moving. Similarly, when process 320 moves between block 324 and 326, as well as block 328 and 330, the parking brake may be engaged to prohibit vehicle 2 from moving. Additional processes may include opening contactors on a battery 42 to prohibit power from going to the powertrain 360.

Redundant Systems

In the present embodiment, redundancies and backup systems are constructed to encourage safe operation of vehicle 2. Requirements of these redundancies may fall within standards such as Automotive Safety Integrity Level D (ASIL-D). Referring now to FIG. 6, a control diagram 350 for the Autonomous Driving System (ADS) 90 will be explained in greater detail. Illustratively, a by-wire steering instrument is depicted by block 205, which is coupled via a Controller Area Network (CAN) to a primary supervisory controller 352 as well as a backup supervisory controller 354. Further, primary supervisory controller 352 and backup supervisory controller 354 are communicably coupled together so that each controller 352, 354 can communicate with each other.

In the present embodiment, the Autonomous Driving System (ADS) 90 will default to the primary supervisory controller 352, and if a fault is detected within the primary supervisory controller 352, the second supervisory controller 354 becomes the default controller. Primary supervisory gateway 352 controls the passage of electronic signals between the ADS and vehicle 2. Illustratively, the primary supervisor gateway 352 is electronically coupled to primary brake controller 358, which provides primary braking force to the service brakes 368 and backup braking force to the parking brake 369. Further, primary supervisory gateway 352 is electronically coupled to a first winding 357 of electronic power steering (EPS) 361. Primary supervisory gateway 352 and backup supervisory gateway 354 are both communicably coupled to a motor control unit (MCU) 356 which controls the powertrain 360 to provide propulsion to vehicle 2. Illustratively, both primary supervisory gateway 352 and backup supervisory gateway 354 may provide signals to the MCU 356 in the event of a failure in the primary supervisory gateway 352. Further, backup supervisory gateway 354 is electronically coupled to a backup brake controller 359 which provides primary braking force to the parking brake 369 and backup braking force to the service brake 368. Additionally, backup supervisory gateway 354 is coupled to a second winding 367 of electronic power steering (EPS) 361.

In various embodiments, primary supervisory gateway 352 and secondary gateway 354 are coupled to a third brake controller 389 which controls the sole parking brake 369, or in other embodiments, an additional parking brake 369′. Brake controller 389 provides additional redundancy to the system and additional safeguards in the event of one or more brake controller failures. In various embodiments, parking brake 369′ is an electronic parking brake coupled directly to motor 364. Further, throttle input 200 is electronically coupled to backup supervisory gateway controller 354 and primary supervisory gateway controller 352. Additionally, both primary supervisory gateway controller 352 and backup supervisory gateway controller 354 are coupled to the Vehicle Control Module (VCM) 355 which may control vehicle level functions (e.g., lights). Further, both gateway controllers 352, 354 may be electronically coupled to a display 61 located within vehicle 2.

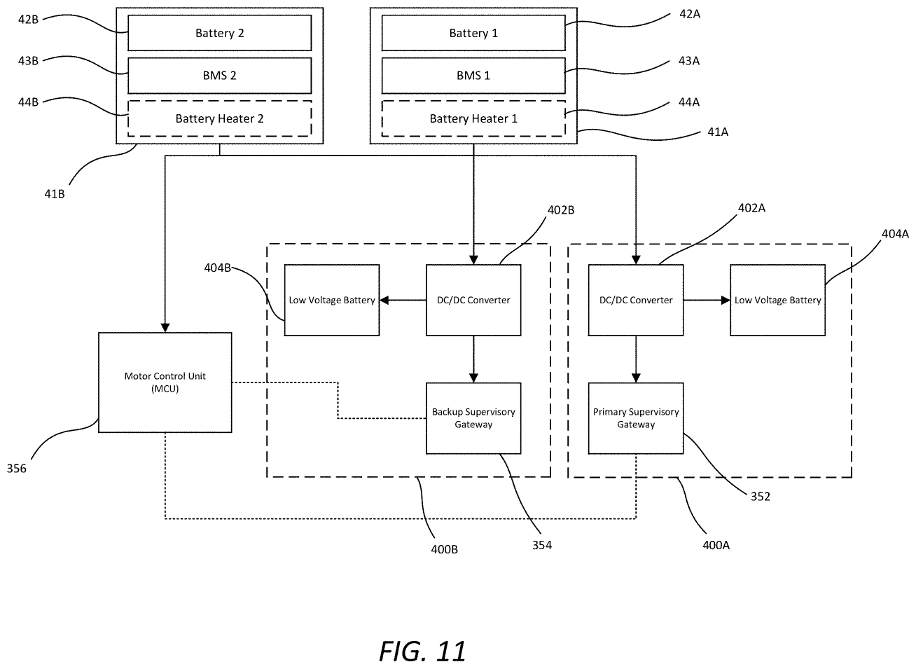

In the present embodiment, control diagram 350 provides pathways for vehicle 2 to monitor various safety critical systems for the operation of the ADS 90. The ADS 90 is configured to process specific instructions if a system fails. In the present embodiment, if primary brake controller 358 fails, ADS 90 shifts control of brake functionality to the secondary brake controller 359. If a failure is detected in service brakes 368, and vehicle 2 is presently slowing down, primary supervisory gateway 352 and backup supervisory gateway 354 will automatically continue to slow the vehicle using the parking brake 369. In the present embodiment, in the event of failure of the parking brake 369, the ADS 90 will engage the service brake 368 to hold the vehicle 2 at a stop. Further, in the event that vehicle 2 experiences a failure of motor control unit 356, the failure will be communicated to the ADS 90 so that vehicle 2 can be derated and brought to a controlled stop through the use of at least one of the control systems of the vehicle (e.g., brakes 368, 369, throttle control 200, battery controller 43 (FIG. 11), electronic power steering 361).

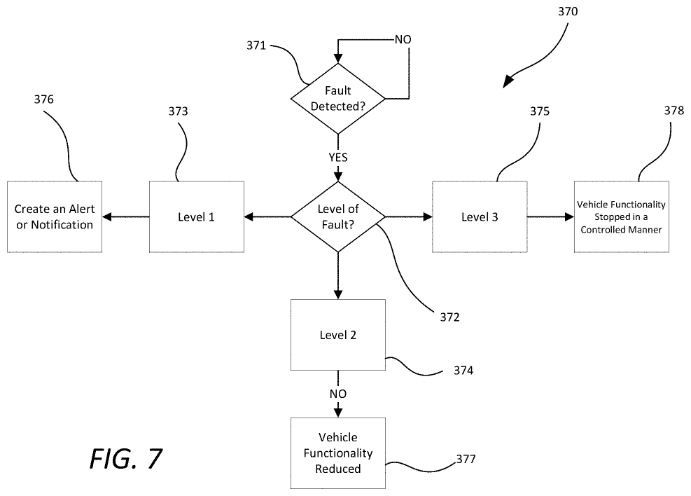

Referring now to FIG. 7, a control logic 370 displaying the failure modes of vehicle 2 is shown. In the present embodiment, the Autonomous Driving System (ADS) 90 is constantly monitoring the systems of vehicle 2 and configured to detect faults within the various systems, as denoted by decision block 371. Illustratively, if a fault is detected, control logic 370 moves to block 372 to categorize the fault into one of various levels. Illustratively, these levels may be a Level 1 fault 373, a Level 2 fault 374, or a Level 3 fault 375. These levels may be separated by a variety of factors affecting vehicle 2 including vehicle performance, vehicle safety or the like. In the present embodiment, a Level 1 fault 373 may include a non-impacting failure, such as a non-functioning cabin light, a removable panel is not installed correctly, or other function that has a low or negligible impact on the vehicle performance or safety. In the event of a Level 1 fault 373 occurring, vehicle 2 may provide a notification or alert to an operator as denoted in block 376, a fleet manager, or a network server 96 through processing circuitry 102 of the Level 1 fault 373. In various embodiments, a Level 2 fault 374 may be classified by the event of a non-critical fault that may have a nominal impact on vehicle performance, such as a failing of the first winding 357 of EPS 361. In the event of a Level 2 fault 374, vehicle 2 may have its functionality reduced (e.g., vehicle speed limited, jerk limits 121, 122 may be limited further, functionality may move to backup controls, etc.) as illustrated in block 377 and may further provide notifications or alerts as found in Level 1 fault 373. In various embodiments, a Level 3 fault 375 may be classified by the event of a critical fault that demonstrably affects vehicle performance and/or vehicle safety (e.g., motor control unit failure, multiple brake failure, etc.). In the event of a Level 3 fault 375, vehicle 2 may take immediate action to mitigate risk and get to a safe state as shown in block 378, which may be a severe reduction in capability such as unengaging the batteries from the powertrain 360, engaging any of brakes 368, 369, or other action. In various embodiments, a Level 3 failure may also combine the actions of a Level 2 failure and/or a Level 1 failure. Thus, it will be appreciated that any of a variety of thresholds and associated vehicle operations and functionality changes may be used.

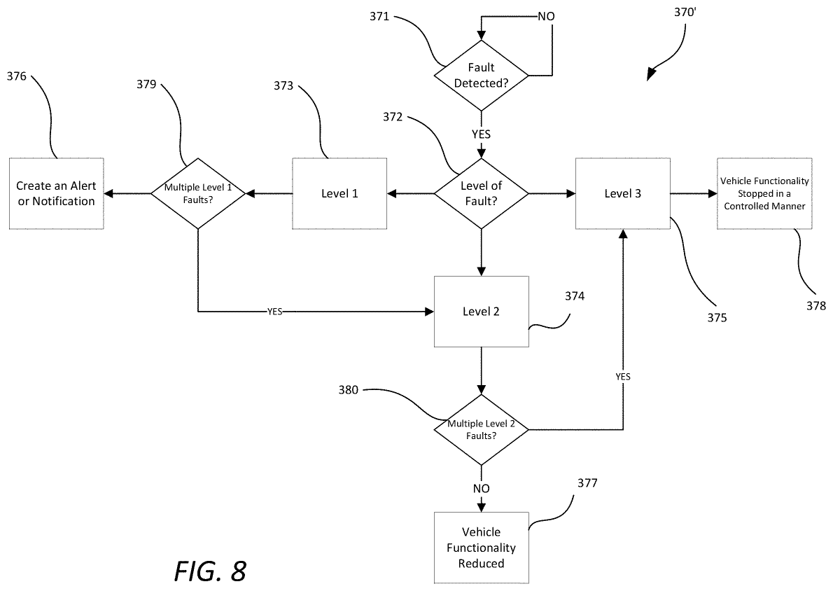

In another embodiment of control logic 370, as illustrated in FIG. 8 as logic 370′, additional blocks may be inserted within the various levels of fault of FIG. 7. Illustratively, after block 373, control logic 370 may ask if there are multiple Level 1 faults 373 present within the system. If the system determines that multiple Level 1 faults 373 are present in block 379, control logic 370 moves on to block 374, thereby elevating the multiple Level 1 faults 373 to a Level 2 fault 374. Similarly, after block 374, control logic 370 may ask if there are multiple Level 2 faults 374 present within the system. If the system determines that multiple Level 2 faults 374 are present in block 380, control logic 370 moves on to block 375, thereby elevating the multiple Level 2 faults 374 to a Level 3 fault 375.

Electronic Power Steering

Now referring to FIGS. 9A-9C, vehicle 2 includes electronic power steering (EPS) system 361 operably coupled to a steering rack 362, which in turn provides steering to ground engaging members 4. Illustratively, as shown in FIGS. 9A-9C, various embodiments of EPS system 361 are shown. As shown in FIG. 9A, electronic power steering 361 may include first unit 347 with first winding 357 directly coupled to the steering rack 362 and second unit 348 with second winding 367 indirectly coupled to steering rack 362 through a steering shaft 363. As further shown in FIG. 9B, EPS system 361 may include first unit 347 with first winding 357 and second unit 348 with second winding 367, both of which are directly coupled to the steering shaft 363. As further shown in FIG. 9C, EPS system 361 may include first unit 347 with first winding 357 and second unit 348 with second winding 367, both of which are directly coupled to the steering rack 362. As is discussed in greater detail below, windings 357 and 367 of units 347 and 348, respectively, may each be individually controllable so as to provide redundant control of the vehicle in the event of the failure of a single winding.

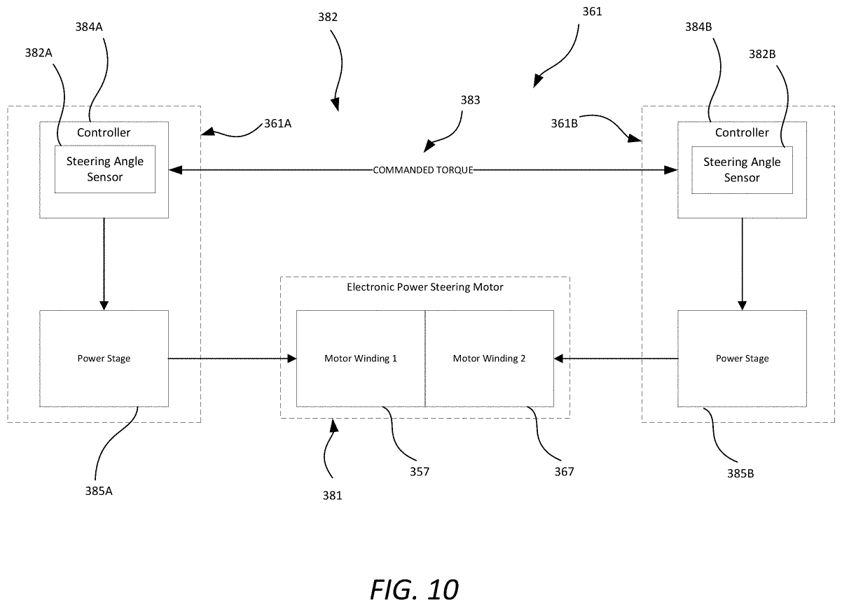

In another example, FIG. 10 depicts an EPS system 361 that includes a single unit with a first motor 381 including a first winding 357 and a second winding 367. First winding 357 and second winding 367 may be placed adjacent to each other within an EPS housing (not shown). Similar to FIGS. 9A-9C, first winding 357 and second winding 367 may be controlled independently of each other. As a result, motor 381 may provide backup functionality via individual operation of first winding 357 or second winding 367 in the event of either winding 367 or 357 failing, respectively. Thus, it will be appreciated that first winding 357 and second winding 367 may each reside in a single motor 381 (as illustrated in FIG. 10), or alternatively, may reside in two separate motors (e.g., as part of first unit 347 and second unit 348 as shown in FIGS. 9A-9C).

Referring again to FIG. 10, a control strategy 382 for the EPS system 361 is illustrated. In various embodiments, first winding 357 and second winding 367 are both present to provide backup steering capabilities to the ADS. For example, first winding 357 and second winding 367 may each be associated with a separate electronic power steering unit (e.g., first unit 347 or second unit 348) or, as illustrated, they may drive a common motor 381 within the electronic power steering 361. First winding 357 and second winding 367 are configured with separate and distinct components (e.g., steering angle sensor) so that a failure of one winding does not affect operation of the other. Illustratively, a first EPS side 361A includes a first steering angle sensor 382A coupled to a first controller 384A and a second EPS side 361B includes a second steering angle sensor 382B coupled to a second controller 384B. Each of steering angle sensor 382A and steering angle sensor 382B provide a steering angle input to a respective controller 384A and 384B, which provides a requested torque to each of the first winding 357 and the second winding 367. Each of steering angle sensor 382A and steering angle sensor 382B are susceptible to providing different steering angle outputs, and thus providing different requested torques from power stages 385A and 385B to each of the first winding 357 and the second winding 367, respectively.

Still referring to FIG. 10, motor 381 receives a steering angle from first EPS side 361A and second EPS side 361B and operates accordingly. In order to mitigate first winding 357 and second winding 367 from providing different torques to motor 381, a feedback loop 383 between the first side EPS 361A and second side EPS 361B is constructed. Feedback loop 33 allows first controller 384A and second controller 384B to communicate with each other and correct their values with respect to each other. In the present embodiment, at a predetermined rate, each controller 384A, 384B communicates their respective steering angle values with each other, and each controller subsequently corrects their steering angle value, or their requested output torque, by a predetermined amount towards the measured value from the other controller. In various embodiments, the first controller 384A and second controller 384B communicate at a rate of 100 Hertz (Hz), and every 10 milliseconds (ms) first controller 384A communicates its steering angle value to second controller 384B. Further, first controller 384A adjusts its steering angle by a 1% increase or decrease in the direction of the steering value of the second controller 384B. In various embodiments, the first controller 384A adjusts the output torque request by a 1% increase or decrease in the direction of the output torque request of the second controller 384B. In various embodiments, the percentage of an increase/decrease may be greater or lower than 1%. In various embodiments, the percentage of an increase/decrease is variable.

The present embodiment is intended to manage the torque output from the first winding 357 and the second winding 367. The output torque request to the first winding 357 and second winding 367 may be blended and will result in a more seamless use by an operator. Further, this feedback loop 382 prevents windup within the motor 381, which can reduce heat and prolong the life of the motor 381. While FIG. 10 is described in an example where controllers 384A and 384B each communicate a respective steering angle value and adjust a respective steering angle accordingly, it will be appreciated that similar techniques may be used in instances where one controller acts as a primary controller (e.g., to affect the behavior of the second, backup controller) or a discrete controller is used to manage operation of both controllers, among other examples.

Battery Redundancy

Now referring to FIG. 11, vehicle 2 includes a first power source 41A and a second power source 41B. In the present embodiment, first power source 41A includes a first battery 42A and a first battery management system 43A, and second power source 42B includes a second battery 42B and second battery management system 43B. In various embodiments, first power source 41A may further include a first battery heater 44A and second power source 41B may further include a second battery heater 44B. Illustratively, a first power side 400A and a second power side 400B are distinct and electrically coupled to both first power source 41A and second power source 41B. First power side 400A includes a DC/DC converter 402A configured to receive power from the first power source 41A and second power source 41B at a first voltage level and output a second voltage to the primary supervisory gateway 352 and a first low voltage battery 404A. Illustratively, second power side 400B includes a DC/DC converter 402B configured to receive power from the first power source 41A and second power source 41B at a first voltage level and output a second voltage to the backup supervisory gateway 354 and a second low voltage battery 404B.

In the present embodiment, two power sources and two batteries are used. In various embodiments, more than two power sources may be used, such as three batteries, four batteries, five batteries, or six batteries, or more batteries. In various embodiments, each battery includes its own battery management system 43 and its own battery heater 44. In various embodiments, all power sources are operably coupled to charger 60 which may provide power to charge the plurality of batteries 42. In various embodiments, each power source 41 may include its own charger. In the present embodiment, batteries 42A and 42B may be charged through the use of a brake regeneration process, which will be described in greater detail below. In the present embodiment, first power source 41A and second power source 41B are configured to provide power directly to the motor control unit 356 at the first voltage level.

In the present embodiment, both batteries 42A and 42B create the total capacity for vehicle 2. Further, the total capacity of batteries 42A and 42B may be split in different ways. In one embodiment, battery 42A may include 50% of the total battery capacity and battery 42B may include the other 50% of the total battery capacity. In another embodiment, battery 42A may include 60% of the total battery capacity and battery 42B may include the other 40% of the total battery capacity. In another embodiment, battery 42A may include 70% of the total battery capacity and battery 42B may include the other 30% of the total battery capacity. In another embodiment, battery 42A may include 80% of the total battery capacity and battery 42B may include the other 20% of the total battery capacity. In another embodiment, battery 42A may include 75% of the total battery capacity and battery 42B may include the other 25% of the total battery capacity. In another embodiment, battery 42A may include 90% of the total battery capacity and battery 42B may include the other 10% of the total battery capacity. Having total battery capacity split between batteries 42A and 42B, vehicle 2 may utilize the power from either battery 42A or battery 42B in the event of a failure in either battery. When both batteries 42A and 42B are fully operational, vehicle 2 operates with the combined power of both batteries.

In various embodiments, either battery, 42A or 42B, may be used and depleted only down to a predetermined reserve power level. In the case that either battery fails, the reserve power level is approximately 10% of the overall power level of the battery 42A or 42B so that a portion of power is available in emergencies. In various embodiments, the reserve battery level is approximately 5% of the overall power level of the battery 42A or 42B. In various embodiments, the reserve battery level is another value, and yet in other embodiments, the reserve battery level is customizable by an operator, a passenger, or a fleet operator.

Low Voltage Interface

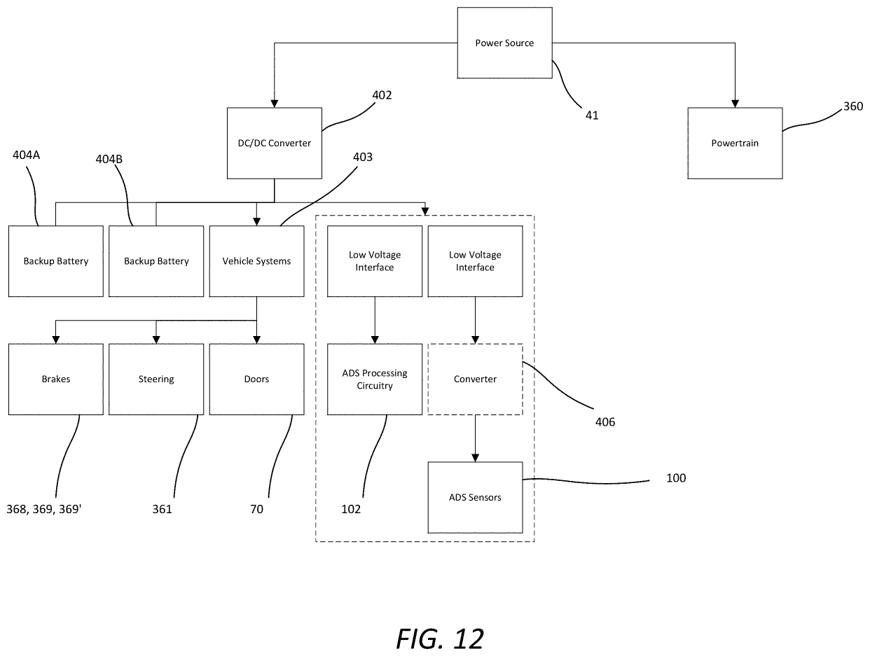

Referring now to FIG. 12, first low voltage battery 404A and second low voltage battery 404B provide power to a variety of components including vehicle subsystems 403 such as brakes 368, 369, doors 15, 16, 25, 26, 35, 36, electronic power steering 361, as well as processing circuitry 102. Illustratively, power source 42 is electrically coupled to the powertrain 360 as well as at least one DC/DC converter 402A. In the present embodiment, DC/DC converter 402 is configured to convert a 48V voltage level power source to a 12V voltage level. In the present embodiment, the output from DC/DC converter 402A is electrically coupled to at least one backup battery 404A and a second backup battery 404B. In various embodiments, more backup batteries may be used. Further, the output from the DC/DC converter 402A is configured to power the Autonomous Driving System (ADS) 90, including the processing circuitry 102 and the ADS sensors 100. In various embodiments, ADS sensors 100 require a different voltage level than processing circuitry 102 and may pass through another DC/DC converter 406. In the present embodiment, low voltage passes through DC/DC converter 406 which elevates the voltage from 12V to a 20V.

In the present embodiment, vehicle systems 403, processing circuitry 102 and ADS sensors 100 are configured to be powered by power source 42 during operation of the vehicle. In the event of a failure of power source 42, the plurality of low voltage batteries 404A and 404B are configured to provide power to the plurality of low voltage systems. In various embodiments, the low voltage batteries 404A and 404B are configured to prioritize critical systems such as the brakes 368, 369, electronic power steering 361, the ADS sensors 100, various lights, communications, doors 15, 16, 25, 26, 35, 36, and locks. Further, low voltage batteries 404A and 404B are sufficiently sized to power the critical systems for a period of time sufficient to control vehicle 2 into a safe state and position and also provide communication system functionality between vehicle 2 and an emergency personnel, fleet manager, or other.

Battery Heater

Vehicle 2 may be operated in cold or cooler conditions which may hinder the operation, the cycle life, or overall performance of batteries 42. To sufficiently increase the ability of batteries 42 to operate within colder temperatures and/or inclement climates, battery heaters 44A may be used with vehicle 2 and operated by and in conjunction with the Autonomous Driving System (ADS) 90. In various embodiments, battery heaters 44 are heating pads positioned on, around, and/or underneath batteries 42. In various embodiments, battery heaters 44 may be heated blowers which push warm air through the volume surrounding batteries 42. In various embodiments, a heater (not shown) that provides air to passengers (not shown) of vehicle 2 is used to provide warm air to batteries 42. In various embodiments, battery heaters 44 may be any other form of thermal producing component configured to provide thermal energy to the volume surrounding batteries 42 and/or the surface of batteries 42 and/or the internal components of batteries 42.

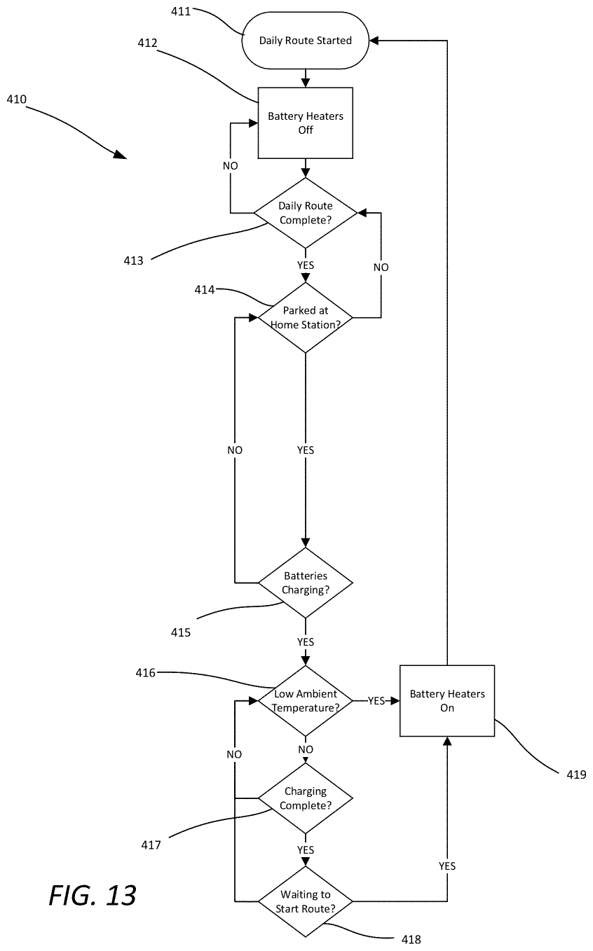

Now referring to FIG. 13, control diagram 410 will be explained in greater detail. Illustratively, control diagram 410 has a starting point at block 411 when a selected route is started. In the present embodiment, this may be when a fleet manager initiates a start sequence, when an operator of vehicle 2 turns a start key to an on, or accessory position, or based upon a timed sequence of events (e.g., vehicle 2 is scheduled to pick-up passengers at 7 a.m., the daily route may start at 6:45 a.m. to pick up passengers on time). In the present embodiment, when the daily route is started, battery heaters 44 are turned off in block 412. Battery heaters 44 may have been turned on as a result of operation 419, which is discussed in greater detail below. In examples, battery heaters 44 are turned off because operation of vehicle 2 is expected to cause the batteries to maintain a suitable temperature. While FIG. 13 is described in an example where battery heaters 44 remain off for the duration of the route, it will be appreciated that other examples may include battery temperature monitoring and associated heating such that the battery temperature remains within a predetermined range or above a predetermined threshold. Examples of such aspects are described below with respect to battery charging. Control diagram 410 will continue to inquire as to whether the daily route is complete in block 413 until the daily route is complete. When the daily route is complete, control diagram will ask a sequence of questions to determine whether battery heaters 44 should be turned back on. Illustratively, if the daily route is complete, control diagram will inquire about the position of vehicle 2 and determine whether vehicle 2 is at a home station (not shown) at block 414, and if the vehicle 2 is at a home station, vehicle 2 must be charging in block 415 to move on to block 416.

In the present embodiment, if the daily route is complete 413, vehicle 2 is parked at its home station 414, and batteries are charging 415, the control diagram 410 moves on to a second set of inquiries which determine when battery heaters 44 are turned back on. Illustratively, if there is a low ambient temperature, determined in block 416, battery heaters 44 will turn on to preserve the battery life, performance, and integrity of batteries 42. In various embodiments, a low ambient temperature may be 32 degrees Fahrenheit, or may be 0 degrees Fahrenheit, or in other embodiments may be another predetermined temperature. In various embodiments, the predetermined temperature may be selected by a user, operator, or fleet manager. In the present embodiment, low ambient temperature is detected by a thermometer on vehicle 2, or a thermocouple on controller 2, or a thermocouple adjacent batteries 42.

In the present embodiment, if a low ambient temperature is not detected, battery heaters 44 do not turn back on and will move to block 417 and inquire as to whether batteries 42 are fully charged or not. If the answer is no, control diagram 410 returns to inquire if a low ambient temperature is detected in block 416. Therefore, battery heaters only turn on before charging is completed only if a low ambient temperature is detected in block 416. If block 417 detects that batteries 42 are fully charged, control diagram will move to block 418 where vehicle 2 waits to start route and return to block 411. In the present embodiment, block 418 may be satisfied by various signals, including a start sequence initiated by an operator, fleet manager or based upon a timed sequence of events, as previously described. In various embodiments, the start sequence may be a delayed start sequence (e.g., an owner schedules vehicle 2 to start at 7:45 a.m., knowing they want vehicle 2 to start the daily route at 8:00 a.m.). Until a daily route is planned to be started in block 418, control diagram 410 will cycle between blocks 416-418 to maintain a battery temperature and a full charge so that vehicle 2 is ready when needed. When block 418 is satisfied, and a daily route is impending, battery heaters 44 will be turned on in block 419 and batteries 42 will be raised to a predetermined temperature before operation of vehicle 2.

In the present embodiment, control diagram 410 and battery heaters 44 are configured to raise the temperature of batteries 42 and/or the volume surrounding batteries 42 to a predetermined temperature. In various embodiments, this predetermined temperature is 32 degrees Fahrenheit, in other embodiments, the predetermined temperature is 50 degrees Fahrenheit, and in yet other embodiments, the predetermined temperature is 65 degrees Fahrenheit.

In various embodiments, batteries 42, battery heaters 44, and control diagram operate in conjunction to determine a time required to heat batteries 42 to a predetermined temperature. Control diagram may use that time required to determine how long before vehicle 2 starts its daily route in block 411 to start battery heaters 44. This may be determined by using inputs from at least the inputs of ambient temperature, battery temperature, battery heater power, battery heater efficiency, and other inputs.

Cold Weather Mode/ABS

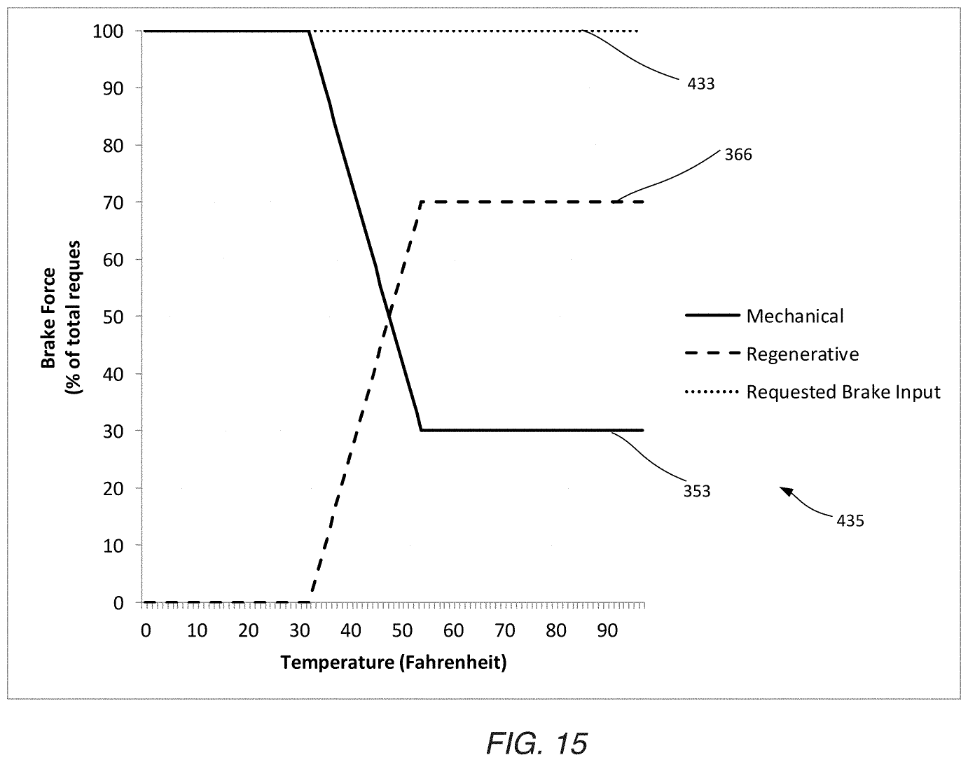

Referring now to FIGS. 14-15, vehicle 2 includes mechanical brakes 368, 369, 369′ to aid in stopping vehicle 2 when desired and brake controllers 358, 359, 389 are able to provide anti-lock brake capabilities to mechanical brakes 368, 369, 369′. Mechanical brakes 368, 369 may be hydraulic brakes. Vehicle 2 is also able to provide braking force 433 to ground engaging members 4, 6 through regenerative braking 365. When vehicle 2 is slowing down, positive current will stop flowing to motors 364 and instead, motor 364 will operate in reverse and act as a generator, creating a flow of energy to be captured by batteries 42. In the present embodiment, vehicle 2 may use a combination of anti-lock braking provided by brake controllers 358, 359, 389 as well as regenerative braking 365 through motor 364 to slow vehicle 2 in the most effective manner. Regenerative braking 365 may be the preferred method of slowing vehicle 2 so that batteries 42 may be recharged as much as possible, however, in certain circumstances, regenerative braking 365 is less desirable, such as cold weather, icy roads, snowy roads, or other slippery conditions. In various embodiments, brake controllers 358, 359, 389 are hydraulic brake controllers. In various embodiments, brake controllers 358, 359, 389 are electronic brake controllers. In a further embodiment, brake controllers 358, 359, 389 are hydraulic and electronic brake controllers.

Referring now to FIG. 14, a braking control strategy 430 is illustrated, and will be described in greater detail. Illustratively, at least one of the primary supervisory gateway controller 352 or the backup supervisory gateway controller 354 receives a brake request input 431. Brake request input 431 may be from an operator of a vehicle operating a brake input (e.g., brake pedal) or may otherwise be received from the Autonomous Driving System (ADS) 90 during the course of operation. Further, at least one of the primary supervisory gateway controller 352 or the backup supervisory gateway controller 354 receives at least one input from a plurality of inputs 432. In the present embodiment, inputs 432 may include at least the following, but not limited to wheel speed, battery charge limits, vehicle speed, ambient temperature, or motor control unit (MCU) charge limits. Inputs 432 influence the method of braking that gateways 352, 354 will request be provided to vehicle 2.

In various embodiments, brakes 368, 369 are biased less than regenerative braking 365 so that more regenerative braking force 366 is being imparted on vehicle 2. In various embodiments, regenerative braking 365 is biased less than brakes 368, 369. Supervisory gateways 352, 354 may include a predetermined ambient temperature which is a threshold for changing the bias between mechanical brakes 368, 369 and regenerative braking 365. In ambient temperatures cooler than the predetermined ambient temperature, gateways 352, 354 may be configured to bias so that more braking force 433 is created from brakes 368, 369 to ensure more reliable braking in slippery conditions. In ambient temperatures warmer than the predetermined ambient temperature, gateways 352, 354 may be configured to bias so that more braking force 433 is created from regenerative braking 365 to ensure that maximum power is produced from motor 364 operating in reverse to charge batteries 42.

In the present embodiment, gateways 352, 354 compare the measured wheel speed to the measured vehicle speed to determine an amount of wheel slip occurring at a given wheel. Wheel slip may indicate that the anti-lock brake system should be engaged. Further, if batteries 42 are already substantially charged, or are just coming off of a charger, it may be desired that mechanical brakes 368, 369 are used in lieu of regenerative braking 365 to optimize performance.

In various embodiments, regenerative braking 365 may include an algorithm that may simulate the anti-lock braking performance of mechanical brakes 368, 369. Motor control unit 356 may provide a negative torque signal for a brief period of time to provide an interrupting pulse to the motor 364 as it slows down. Motor control unit 356 may provide alternating signals of no torque (e.g., energy harvesting during regenerative braking) and negative torque (e.g., slow the speed of motor 364). Motor control unit 356 provides motors 364 with pulsing current which simulates the pulses of a mechanical anti-lock brake system. In various embodiments, the period between pulses and/or the size of the current pulse provided to motors 364 may be determined by gateways 352, 354 in response to at least brake request input 431 and/or inputs 432. In various embodiments, the period may be altered continuously based upon changing values from brake request input 431 and/or inputs 432. In various embodiments, gateways 352, 354 may request a period that is equivalent to that of which brake controller 351 requests of mechanical brakes 368, 369. Gateways 352, 354 may provide different levels of anti-lock braking to any of ground engaging members 4, 6 than the other ground engaging members, and may create enhanced driving performance during braking, cornering, and/or acceleration. Additional details about stability mode and anti-rollover protection may be found in U.S. application Ser. No. 17/235,322, filed Apr. 20, 2021, published as U.S. Patent Publication No. 2021/0323515, titled “SYSTEMS AND METHODS FOR OPERATING AN ALL-TERRAIN VEHICLE;” U.S. Pat. No. 10,363,941, issued Jul. 30, 2019, titled “System and Method for Controlling a Vehicle;” U.S. patent application Ser. No. 16/401,933, filed May 2, 2019, published as U.S. Patent Publication No. 2019/0337497, titled “Operating Modes Using a Braking System for an All-Terrain Vehicle;” U.S. Pat. No. 10,118,447, issued Nov. 6, 2018, titled “Hybrid Utility Vehicle;” U.S. patent application Ser. No. 15/816,368, filed Nov. 17, 2017, published as U.S. Patent Publication No. 2018/0141543, titled “Vehicle Having Adjustable Suspension,” docket PLR-15-25091.08P-US-e; U.S. Pat. No. 9,358,882, issued Jun. 7, 2016, titled “Default Open Differential Control Switch;” U.S. Pat. No. 10,086,698, issued Oct. 2, 2018, titled “Electronic Throttle Control,” the entire disclosures of which are expressly incorporated herein by reference for all purposes.

In various embodiments, vehicle 2 may be configured to disable regenerative braking 365 when ambient temperature passes below a certain temperature. In various embodiments, regenerative braking 365 disables under 32 degrees Fahrenheit. In various embodiments, regenerative braking 365 disables under 20 degrees Fahrenheit. In various embodiments, regenerative braking 365 disables under 0 degrees Fahrenheit.

In various embodiments, vehicle 2 may be configured to mesh the mechanical brake force 353 from mechanical brakes 368, 369 and the regenerative brake force 366 from regenerative braking 365 to equal the total requested brake force input 431 from a user or the Autonomous Driving System (ADS) 90. Referring now to FIG. 15, an embodiment of meshing braking force in vehicle 2 can be seen. Illustratively, a chart 435 shows that mechanical brakes 368, 369 and regenerative brakes 365 provide the totality of the requested brake force 433 from brake request input 431 at all ambient temperatures. Further, in various embodiments, mechanical brake force may be 100% of the total requested brake force 433 for lower ambient temperatures below 32 degrees Fahrenheit, and regenerative brakes 365 provide 0% of the total requested brake force 433. Further, between 32 degrees Fahrenheit and approximately 55 degrees Fahrenheit, the mechanical brake force 353 may decrease, while the regenerative brake force 366 may increase, and the sum of the mechanical brake force 353 and the regenerative brake force 366 equals the total requested brake force 433. Illustratively, at a predetermined temperature, a maximum amount of regenerative brake force 366 may be generated and supplemented by mechanical brake force 353 to create the total brake force 433.

Occupant Sensing

Turning to FIG. 16, first passenger section 10 includes a first seat 13 and a second seat 14 and a first door 15 and a second door 16, second passenger section 20 includes a third seat 23 and a fourth seat 24 and a third door 25 and a fourth door 26, and third passenger section 30 includes a fifth seat 33 and a sixth seat 34 and a fifth door 35 and a sixth door 26. Vehicle 2 includes a cabin area generally surrounded by the doors 15, 16, 25, 26, 35, 36. Additionally, vehicle 2 includes a plurality of sensors 500 positioned within first passenger section 10, second passenger section 20, third passenger section 30. Sensors 500 may be a RADAR, LiDAR, and/or image sensor configurable to operate in the visible or invisible light spectrum. Sensors 500 are placed to view and determine if an occupant is present in each of first seat 13, second seat 14, third seat 23, fourth seat 24, fifth seat 33, and sixth seat 34. Illustratively, one sensor 500 is used for each seat, in various embodiments, one sensor 500 is used for each passenger section 10, 20, 30, in various embodiments, one sensor 500 is used for all of vehicle 2. In various embodiments, more than one sensor 500 is used per seat 13, 14, 23, 24, 33, 34.

In the present embodiment, sensors 500 detect the occupancy status of each seat 13, 14, 23, 24, 33, 34 and determine if a passenger is present in each of the seats and report this to the Autonomous Driving System (ADS) 90. Additionally, sensors 500 detect if a passenger within any of seats 13, 14, 23, 24, 33, 34 are wearing a seat belt (not shown). The use of RADAR or LiDAR sensors 500 allows the system to work in any lighting or visibility conditions within the vehicle 2. In the present embodiment, as seen in FIG. 16, vehicle 2 includes a plurality of cross-frame members 11 configured to extend horizontally across vehicle 2. Sensors 500 are coupled to cross-frame members 11 at a height above the floor of passenger sections 10, 20, 30. In various embodiments, sensors 500 are positioned at a height above seats 13, 14, 23, 24, 33, 34.

In the present embodiment, vehicle 2 uses the occupancy of seats 13, 14, 23, 24, 33, 34 to better serve passengers within vehicle 2 and passengers to be picked up by vehicle 2. If sensors 500 detect that seats 13, 14, 23, 24, and 33 are filled by occupants, when vehicle 2 approaches a stop to pick up a new passenger, vehicle 2 may provide easier ingress to the new passenger by opening door 36, adjacent sixth seat 34. Further, if sensors 500 detect that multiple seats have vacancies, Autonomous Driving System (ADS) 90 may direct a specific door to be opened based upon various inputs including but not limited to what side of vehicle 2 the new passenger is on, passenger preference, weight distribution, fleet management preferences, or other.

During a stop to pick up a new passenger, sensors 500 work in conjunction with sensors 100 to provide the Autonomous Driving System (ADS) 90 with a complete view of inside and outside vehicle 2. The ADS can then determine if a person, an obstacle, or other object is within the motion of the door to be opened and pause opening that door on vehicle 2 until the person, obstacle or other object is clear of the motion of that door. Further, sensors 100 may detect which side of vehicle 2 a new passenger will be picked up on, which may determine which door will open on vehicle 2 for the new passenger to enter the vehicle through (e.g., if passenger is entering on the side of seat 13, 23, 33, any of doors 15, 25, 35 may open). Sensors 500 and sensors 100 may further detect other dynamic objects surrounding vehicle 2 to determine which door may be safest for an entering passenger to enter. The safety of the entering passenger supersedes other criteria such as passenger preference when determining which seat the entering passenger will be allotted (e.g., if another vehicle is approaching the side of seat 13, the doors adjacent seat 13, 23, 33 will not open, only a door adjacent seat 14, 24, 34 will open until the object is gone.).

In various embodiments, sensors 500 detect if passengers have appropriately fitted their seat belt (not shown) on their body. If the sensors 500 detect that any passenger has not appropriately fitted their seat belt, Autonomous Driving System (ADS) 90 may instruct vehicle 2 to not move or reduce its performance by doing at least one of withholding a current to motors 364, limiting a top speed, engaging brakes 368 or 369, or other performance limiting action. Further, if sensors 500 detect that any passenger has not appropriately fitted their seat belt, vehicle 2 may warn passengers that one or more passengers is being unsafe and the trip will not resume until all passengers have fitted their seat belts.

In the present embodiment, if vehicle 2 detects a stop coming up for a passenger, Autonomous Driving System 90 may direct a door adjacent the departing passenger to open so that the passenger may exit the vehicle 2. Further, the door adjacent the departing passenger will not open until vehicle 2 has come to a complete stop. After sensors 500 and sensors 100 detect that the departing passenger has left their seat and moved far enough away from vehicle 2, the Autonomous Driving System 90 will direct the open door to be closed. Additionally, if sensors 500 and/or 100 detect that the surrounding area around the departing passenger is unsafe (e.g. moving vehicle), the door may be prohibited from opening until the area is safe for egress.

Door Control

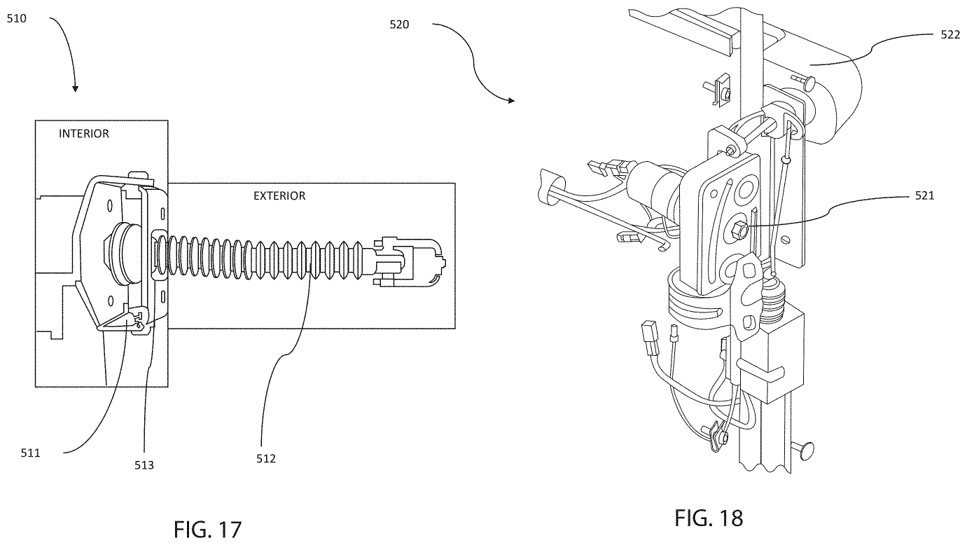

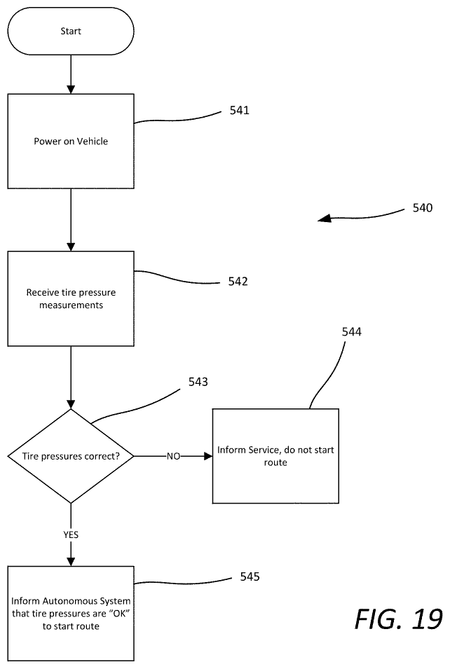

Now referring to FIGS. 17-18, within each of doors 15, 16, 25, 26, 35, 36, an actuator 510 is positioned to control the opening and closing of the doors. In the present embodiment, actuator 510 is placed adjacent a hinge 511 on each of doors 15, 16, 25, 26, 35, 36. Illustratively, linking mechanism, or latching mechanism, 512 extends through an opening in hinge 511 and couples to the door. In the present embodiment, linking mechanism 512 couples to an exterior portion of the door. In the present embodiment, the actuator 510 is a linear actuator. Further, linking mechanism 512 is actuatable between a first position and a second position, wherein in the first position the linking mechanism 512 is shorter than when in the second position and the door is closed. Wherein in the second position the linking mechanism 512 is longer than in the first position and the door is open. In the present embodiment, linking mechanism 512 is infinitely actuatable between the first position and second position. Linking mechanism 512 may actuate via a linear actuator, a rotational pulley, or other form of actuator.

In some examples, vehicle 2 may include an actuator 510 to assist in the opening and closing of doors 15, 16, 25, 26, 35, 36 during operation. When a new passenger is to be picked up, a door must be opened to allow ingress by the new passenger. To open any of doors 15, 16, 25, 26, 35, 36, linking mechanism 512 may be a solid rod or stiff cable or the like to push open the door. In the present embodiment, doors 15, 16, 25, 26, 35, 36 are constructed of a lightweight material so that the effort required of linking mechanism 512 and actuator 510 is low. Further, when closing the door, actuator 510 must be able to bring the door to a complete close, but also must have sufficient torque and power to properly seal the door. To properly seal the door, actuator 510 may need to provide a higher level of torque or power during the last portion of travel of actuator 510 to cinch the door 15, 16, 25, 26, 35, 36 to the frame assembly 8. Actuator 510 may cinch the door 15, 16, 25, 26, 35, 36 through a variety of means such as a locking cam mechanism (not shown).

In various embodiments, actuator 510 may have a variable force for closing any of doors 15, 16, 25, 26, 35, 36 based upon the environment around it. Actuator 510 is in communication with the Autonomous Driving System (ADS) 90 so that it may open and close doors based upon needed ingress/egress from passengers. In various embodiments, the ADS 90 may communicate to the mechanical actuator 510 that a higher force is required than normal due to high winds and/or because vehicle 2 is sitting with the door facing downhill. Before ADS 90 commands actuator 510 to produce a higher force, the ADS 90 may assess the surrounding environment to determine if it is safe to utilize a higher force, or if there is a high level of pinching an object, or person in the door with the higher force. Alternatively, if the ADS 90 determines that winds are normal and/or vehicle 2 is sitting with the door facing uphill, the ADS 90 may determine that a lesser force is required to close the door, and command actuator 510 to close the door with a lesser force. Similarly, if the ADS 90 is aware of a high probability of pinching an object or person, the ADS 90 may command the actuator 510 to close the door with a lesser force.

In the present embodiment, doors 15, 16, 25, 26, 35, 36 further include a locking mechanism 520. Locking mechanism 520 is both manually and automatically actuatable. Illustratively, locking mechanism 520 includes a handle 522 exterior to the door, and a motor 521 located within the door, or on an inside panel of the door. In the present embodiment, the actuation of handle 522 will engage and/or disengage the latching mechanism within locking mechanism 520. Further, motor 521 is actuatable to engage or disengage the latching mechanism within locking mechanism 520.

In the present embodiment, motor 521 is electrically coupled to the Autonomous Driving System (ADS) 90 such that the ADS 90 can monitor the status of the locking mechanism 520 and also control the engagement and disengagement of locking mechanism 520. In the present embodiment, the ADS 90 may lock the door when desired and unlock the door when desired. In the present embodiment, when vehicle 2 is moving, the ADS 90 will command the locking mechanism 520 to remain locked. Additionally, when vehicle 2 is parked, the ADS 90 will allow the locking mechanism 520 to be unlocked, and may further command the locking mechanism 520 of a specific door to be unlocked to allow egress from a departing passenger. In various embodiments, when vehicle 2 is parked and not moving, the ADS 90 commands all doors 15, 16, 25, 26, 35, 36 to be unlocked.

In the present embodiment, locking mechanism 520 includes an override feature (not shown) that automatically unlocks the door in case of an emergency situation. Override feature may be a button, a lever, or other user actuatable feature to indicate an emergency situation. In various embodiments, when override feature is actuated, the Autonomous Driving System 90 is notified and an alert is provided to any of all the passengers, an operator, an owner, a fleet manager, emergency authorities, or custom groups of people.

In various embodiments, locking mechanism 520 works in conjunction with sensors 500 and sensors 100 to determine when a passenger is entering or leaving so that a door may be unlocked to allow a passenger to leave or enter and a door may be locked after a passenger has left or has entered. In various embodiments, if sensors 500 and sensors 100 determine that the environment outside vehicle 2 is unsafe for passengers, the ADS 90 may command the locking mechanism 520 to remain locked to inhibit passengers exiting vehicle 2.

BTLE Tire Pressure Sensing

In the present embodiment, vehicle 2 includes a plurality of tire pressure sensors (not shown) each coupled to one of the plurality of ground engaging members 4, 6. Further, tire pressure sensors are electrically coupled to the Autonomous Driving System (ADS) 90, and the ADS 90 receives signals from the plurality of tire pressure sensors indicating a pressure of the ground engaging members 4, 6, for example via a radio signal such as using Bluetooth Low Energy (BTLE). In various embodiments, the Autonomous Driving System 90 will utilize a control logic 540 to determine if the air pressure within ground engaging members 4, 6 is sufficient to drive vehicle 2. By controlling operation of vehicle 2 based on tire pressure measurements, ADS 90 may be configured to further improve safe operation of vehicle 2.

Illustratively, control logic 540 starts with a vehicle power-on sequence in block 541. When vehicle 2 is powered on, the ADS 90 receives tire pressure measurements from the tire pressure sensors in block 542. The ADS 90 will inquire as to if the tire pressure measurements are correct in block 543 and if tire pressures are correct, the Autonomous Driving System 90 will allow vehicle 2 to operate in block 545. Further, if ADS 90 determines the tire pressures are incorrect and insufficient, the Autonomous Driving System 90 will not allow vehicle 2 to operate in block 544. Further, in the event the ADS 90 determines the tire pressures are incorrect in block 544, the ADS 90 may further notify a user, operator, passenger, fleet manager, or network manager that the vehicle 2 requires additional air pressure in ground engaging members 4, 6. It will be appreciated that an intermediate tire pressure state may be identified in other examples, for example where the tire pressure is below an acceptable threshold but above a failure threshold. In such instances, vehicle operation may be derated, or a vehicle characteristic may be altered (e.g., a maximum vehicle speed), and an indication may be provided to the operator or fleet manager, among other examples.

While this invention has been described as having an example design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a plurality of ground engaging members;
a frame supported by the plurality of ground engaging members;
a plurality of sensors supported by the frame, the plurality of sensors including:
a first set of sensors positioned on a top of the frame;
a second set of sensors positioned at a front of the frame;
a third set of sensors positioned at a rear of the frame; and
a fourth set of sensors positioned at a side of the frame; and
processing circuitry communicatively coupled to the plurality of sensors.

2. The vehicle of claim 1, wherein the plurality of sensors includes at least one of a radar sensor, an ultrasonic sensor, or a Light Detection and Ranging (LiDAR) sensor.

3. The vehicle of claim 1, wherein the plurality of sensors includes a sensor positioned at each corner of the vehicle.

4. The vehicle of claim 1, wherein the plurality of sensors is configured to provide coverage of a 360-degree environment around the vehicle.

5. The vehicle of claim 1, wherein the processing circuitry is configured to perform a set of operations, the set of operations comprising at least one of:
calibrating a sensor of the plurality of sensors based on a test piece identified in a path of the vehicle; and
adapting a behavior of the vehicle based on sensor output of the plurality of sensors.

6-23. (canceled)

24. A vehicle, comprising:
a plurality of ground engaging members;
a frame supported by the plurality of ground engaging members, the frame including an operator area; and
processing circuitry configured to perform a set of operations comprising:
determining whether the operator area is configured for manual operation;
when it is determined that the operator area is configured for manual operation, configuring the vehicle to operate in a manual mode; and
when it is determined that the operator area is not configured for manual operation, configuring the vehicle to operate in an automatic mode.

25. The vehicle of claim 24, further comprising a manual control removably coupled to the operator area.

26. The vehicle of claim 25, wherein it is determined that the operator area is configured for manual operation when the manual control is removably coupled to the operator area.

27. The vehicle of claim 24, wherein it is determined that the operator area is not configured for manual operation when a removable panel is installed in the operator area, wherein the removable panel obstructs access to a manual control of the operator area.

28. The vehicle of claim 27, wherein the processing circuitry is further configured to provide an indication when it is determined that the removable panel is not installed correctly.

29. The vehicle of claim 24, wherein electrical input received from a manual control of the operator area is used by the processing circuitry to control the vehicle in the manual mode.

30. The vehicle of claim 24, wherein the vehicle further comprises a key switch having a first position associated with the manual mode and a second position associated with the automatic mode.

31. The vehicle of claim 30, wherein determining whether the operator area is configured for manual operation further comprises determining whether the key switch is in the first position associated with the manual mode.

32. The vehicle of claim 30, wherein the processing circuitry is further configured to provide an indication when a mismatch is identified between a configuration of the operator area and a position of the key switch.

33. The vehicle of claim 24, wherein a manual control of the operator area includes at least one of a treadle pedal, a throttle pedal, a brake pedal, or a steering input.

34. A vehicle, comprising:
a plurality of ground engaging members;
a frame supported by the plurality of ground engaging members;
a first supervisory gateway and a second supervisory gateway each supported by the frame; and
processing circuitry communicatively coupled to the first supervisory gateway and the second supervisory gateway, the processing circuitry configured to perform a set of operations comprising:
controlling, using the first supervisory gateway, a vehicle subsystem;
identifying a fault of the first supervisory gateway; and
in response to identifying the fault of the supervisory gateway, using the second supervisory gateway to control operation of the vehicle.

35. The vehicle of claim 34, wherein:
the first supervisory gateway is communicatively coupled to a first brake controller, a motor control unit, and an electronic power steering system; and
the second supervisory gateway is communicatively coupled to a second brake controller, the motor control unit, and the electronic power steering system.

36. The vehicle of claim 34, wherein the processing circuitry is further configured to:
in response to determining the fault is associated with a first threshold, using the second supervisory gateway to bring the vehicle to a stop;
in response to determining the fault is associated with a second threshold, using the second supervisory gateway to operate the vehicle at reduced functionality; and
in response to determining the fault is associated with a third threshold, generating an indication associated with the identified fault.

37. A vehicle, comprising:
a plurality of ground engaging members;
a frame supported by the plurality of ground engaging members;
a steering rack coupled to at least one of the plurality of ground engaging members;
an electronic power system operably coupled to the steering rack, wherein the electronic power system includes a first winding and a second winding;
a first controller communicatively coupled to the first winding of the electronic power system; and
a second controller communicatively coupled to the second winding of the electronic power system.

38. The vehicle of claim 37, wherein:
the vehicle further comprises:
a first steering angle sensor associated with the first controller;
a second steering angle sensor associated with the second controller;
the first controller is configured to control the first winding of the electronic power system based on the first steering angle sensor; and
the second controller is configured to control the second winding of the electronic power system based on the second steering angle sensor.

39. The vehicle of claim 37, wherein:
the first controller and the second controller are communicatively coupled;
the first controller is configured to:
generate a first adjusted steering angle based on a steering angle obtained from the second controller; and
control the first winding of the electronic power system based on the first adjusted steering angle; and
the second controller is configured to:
generate a second adjusted steering angle based on a steering angle obtained from the first controller; and
control the second winding of the electronic power system based on the second adjusted steering angle.

40. The vehicle of claim 37, wherein the electronic power system uses the second winding and the second controller to operate at reduced functionality as a result of a failure of at least one of the first controller or the first winding.

41. The vehicle of claim 37, wherein the first winding and the second winding form an electronic power steering motor of the electronic power steering system.

42. A vehicle, comprising:
a plurality of ground engaging members;
a frame supported by the plurality of ground engaging members;
a first power source supported by the frame, the first power source comprising:
a first battery; and
a first battery management system;
a second power source supported by the frame, the second power source comprising:
a second battery; and
a second battery management system; and
a motor control unit electrically coupled to both the first power source and the second power source.

43. The vehicle of claim 42, further comprising:
a first DC/DC converter configured to supply power to the motor control unit from the first power source; and
a second DC/DC converter configured to supply power to the motor control unit from the second power source.

44. The vehicle of claim 42, further comprising a first low voltage battery associated with the first power source and a second low voltage battery associated with the second power source.

45. The vehicle of claim 42, wherein the first power source further comprises a first battery heater and the second power source further comprises a second battery heater.

46. The vehicle of claim 42, wherein the first power source and the second power source together form a total battery capacity for the vehicle.

47. The vehicle of claim 42, wherein processing circuitry of the vehicle is configured to limit depletion of the first power source to a predetermined threshold, thereby retaining a power level of the first power source in the event of a failure of the second power source.

48. The vehicle of claim 47, wherein the predetermined threshold is user-configurable.

49. A vehicle, comprising:
a plurality of ground engaging members;
a frame supported by the plurality of ground engaging members;
a first low-voltage battery supported by the frame;
a second low-voltage battery supported by the frame;
a DC/DC converter electrically coupled to the first low-voltage battery and the second low-voltage battery; and
a vehicle subsystem electrically coupled to the first low-voltage battery, the second low-voltage battery, and the DC/DC converter, wherein at least one of the first low-voltage battery or the second low-voltage battery powers the vehicle subsystem when the DC/DC converter experiences a failure.

50. The vehicle of claim 49, wherein the DC/DC converter supplies power to the first low-voltage battery and the second low-voltage battery from a power source having a comparatively higher voltage than the first low-voltage battery and the second low-voltage battery.

51. The vehicle of claim 49, wherein:
the vehicle subsystem is one of a set of critical subsystems; and
the first low-voltage battery and the second low-voltage battery are configured to prioritize the set of critical subsystems over other vehicle subsystems.

52. The vehicle of claim 51, wherein the set of critical subsystems includes at least one of a braking system, an electronic power steering system, an autonomous driving system, a set of sensors, vehicle lighting, a communication system, a door of the vehicle, or a lock of the vehicle.

53. A method for controlling a battery system of a vehicle, the method comprising:
determining an ambient temperature;
comparing the ambient temperature to a temperature threshold;
when it is determined that the vehicle is charging and the ambient temperature is below the temperature threshold:
turning on a battery heater of the battery system to provide thermal energy to the battery; and
in response to identifying a start of a route, turning off the battery heater.

54. The method of claim 53, further comprising:
determining that the vehicle is done with the route before turning on the battery heater.

55. The method of claim 54, further comprising:
determining that the vehicle is parked at a home station before turning on the battery heater.

56. The method of claim 53, wherein the temperature threshold is selected by one of an operator or a fleet manager.

57. A method for controlling a battery system of a vehicle, the method comprising:
determining a position of the vehicle;
determining an ambient temperature;
determining a charge status of the battery; and
when the vehicle receives a start sequence:
turning on the battery heaters based upon at least one of the position of the vehicle, the ambient temperature, and the charge status of the vehicle.

58. The method of claim 57, wherein the battery heaters are turned on when an ambient temperature is below a temperature threshold and the vehicle is positioned at a home station.

59. The method of claim 57, wherein the battery heaters are turned on when an ambient temperature is equal to or above a temperature threshold and the battery is fully charged.

60. A method of braking a vehicle with an electric motor, the method comprising:
receiving a brake request input that indicates a requested braking force;
determining an ambient temperature of the vehicle; and
when the ambient temperature is below a predetermined threshold:
engaging a mechanical brake of the vehicle to provide a first portion of the braking force; and
configuring the electronic motor to perform regenerative braking to provide a second portion of the braking force.

61. The method of claim 60, wherein the combination of the first portion of the braking force from the mechanical brake and the second portion of the braking force from regenerative braking provide the requested braking force.

62. The method of claim 60, wherein configuring the electric motor to perform regenerative braking comprises providing a sequence of interrupted negative torque signals.

63. A method of providing anti-lock braking for a vehicle with an electric motor, the method comprising:
detecting a slip of at least one of a plurality of ground engaging members of the vehicle; and
in response to detecting the slip:
determining a first braking force associated with a brake of the vehicle;
determining a second braking force associated with the electric motor; and
configuring the vehicle according to the determined first braking force and the determined second braking force.

64. The method of claim 63, wherein configuring the vehicle includes providing an alternating signal to the electric motor associated with the determined second braking force, the alternating signal comprising a first torque request and a second torque request.

65. The method of claim 64, wherein the first torque request is a negative torque, and the second torque request is a request for no torque.

66. The method of claim 63, wherein the second braking force is greater than the first braking force when it is determined that an ambient temperature associated with the vehicle is above a predetermined threshold.

67. The method of claim 63, wherein the first braking force is greater than the second braking force when it is determined that an ambient temperature associated with the vehicle is below a predetermined threshold.

68. A vehicle comprising:
a plurality of ground engaging members;
a frame supported by the plurality of ground engaging members;
a first passenger section of the frame, the first passenger section comprising a first seat;
an imaging sensor supported by the frame and positioned to observe the first passenger section, the imaging sensor configured to observe a first passenger within the first seat.

69. The vehicle of claim 68, wherein the sensor is positioned longitudinally forward of the first seat.

70. The vehicle of claim 68, wherein the first passenger section comprises a second seat, and the imaging sensor is further configured to observe a second passenger within the second seat.

71. The vehicle of claim 68, further comprising a controller configured to detect if the first passenger is wearing a seat belt.

72. The vehicle of claim 71, wherein the controller is further configured to reduce performance of the vehicle when it is determined that the passenger is not wearing the seat belt.

73. The vehicle of claim 68, wherein the imaging sensor is one of a RADAR sensor, a LiDAR sensor, or an optical sensor.

74. A vehicle comprising:
a plurality of ground engaging members;
a frame supported by the ground engaging members;
a door supported by the frame;
a latching mechanism coupled between the door and the frame, adjacent to a door hinge of the door; and
a controller supported by the frame, the controller communicatively coupled to the latching mechanism to control a position of the door.

75. The vehicle of claim 74, further comprising a sensor supported by the frame, wherein the sensor is configured to observe a passenger within the vehicle.

76. The vehicle of claim 75, wherein the latching mechanism is configured to move the door between a first position and a second position.

77. The vehicle of claim 76, wherein the controller is configured to cause the latching mechanism to move the door between the first position and the second position when the vehicle is at a vehicle stop of a route of the vehicle.

78. The vehicle of claim 76, further comprising a locking mechanism configured to lock and unlock the door to the frame; and
the locking mechanism locking the door to the frame when the door is in the first position.

79. A method of controlling the operation of a vehicle, the method comprising:
identifying a vehicle power-on sequence;
determining, in response to the identification of the vehicle power-on sequence, an air pressure of a wheel of the vehicle; and
in response to determining the air pressure of the wheel is below an air pressure threshold, preventing operation of the vehicle.

80. The method of claim 79, further comprising:
providing a notification to a user device that the air pressure of the wheel is below the air pressure threshold.

81. The method of claim 79, further comprising:
in response to determining the air pressure of the wheel is above the air pressure threshold, permitting normal operation of the vehicle.

82. A method of controlling the operation of a vehicle, the method comprising:
identifying a vehicle power-on sequence;
determining, in response to the identification of the vehicle power-on sequence, an air pressure of a wheel of the vehicle; and
in response to determining the air pressure of the wheel is below an air pressure threshold, altering a vehicle characteristic.

83. The method of claim 82, wherein the vehicle characteristic is a maximum vehicle speed.
